(19) United States
(12) Patent Application Publication
(10) Pub. No.: US 2024/0396610 A1
(43) Pub. Date: Nov. 28, 2024

(54) System architectures for low earth orbit (LEO) satellite communication systems using fractionated satellites and high-resolution spatial multiplexing

(71) Applicant: Santanu Dutta, Vienna, VA (US)

(72) Inventor: Santanu Dutta, Vienna, VA (US)

(21) Appl. No.: 18/831,046

(22) Filed: May 16, 2024

Related U.S. Application Data
(60) Provisional application No. 63/577,804, filed on May 24, 2023.

(51) Int. Cl. H04B 7/06; H04B 7/0413; H04L 5/00

(52) U.S. Cl. CPC H04B 7/0626; H04B 7/0413; H04L 5/0048

(57) ABSTRACT

A wireless communication system using a fractionated LEO satellite, wherein a combination of MIMO and geographic beamforming are used for radio access, and wherein the channel coefficient vectors are adaptively extrapolated in time and frequency to reduce the pilot signal density.

### CROSS REFERENCE TO RELATED PATENT APPLICATIONS

This application is related to U.S. Provisional Application No. 63/577,804 filed May 24, 2023 and is hereby incorporated herein by reference in its entirety.

The background of the present inventions is described in Dutta, U.S. Pat. No. 11,894,911, which is incorporated herein by reference in its entirety, and is referred to as the Reference System. It is an example prior art system to which the innovations described here may be applied. The innovations could equally be applied to other systems, differing from the Reference System, and are covered by the present invention disclosures.

### FIELD

The present disclosure is directed to methods and systems for LEO satellite communications, particularly methods and systems utilizing fractionated satellites and constellations with large baselines.

### REFERENCES

Avellan, et al., “System and method for high throughput fractionated satellites (HTFS) for direct connectivity to and from end user devices and terminals using flight formations of small or very small satellites”, U.S. Pat. No. 9,973,266, May 15, 2018

### BACKGROUND

There is a resurgence of interest and investment in Low Earth Orbit (LEO) satellites, especially very small satellites weighing 10 kgs to 500 kgs, variously categorized as nanosatellite to small satellite. Several reasons have been attributed to this phenomenon. These include: low manufacturing and launch costs; the ability of present technologies to deliver traditional satellite functions in much smaller sizes; and better ability to back up cellular networks due to the lower latencies and superior link margins of LEOs compared to Geosynchronous (GEO) satellites. Technology advances that support LEO satellite development include: software designed radio (SDR), advances in radio frequency integrated circuits (RFICs), and new signal processing algorithms, particularly in the domain of Multiple Input Multiple Output (MIMO) signal processing.

A previously granted patent, Dutta, S., U.S. Pat. No. 11,894,911, described how a fractionated satellite using a very large baseline, such as several hundred wavelengths at an operating frequency of 800 MHZ, and additional innovations such as multiuser MIMO ((MU MIMO) could overcome previous obstacles to realizing practical fractionated satellites. The architecture of the above system yielded huge increases in the capacity density of the satellite network, enabling full-bandwidth spectrum sharing between user separated on the ground by as little as 250 m. This system provides the contextual backdrop for the innovations described herein.

### SUMMARY

The present disclosure describes a wireless communication system using a large-baseline fractionated satellite and MIMO radio access, wherein characteristics of the LEO satellite channel are exploited to optimize the air interface and other aspects of the system architecture. An example is leveraging the low multipath of a satellite channel to predict the channel coefficient vectors in time and frequency, thereby reducing the pilot signal density. Also described is a method of optimizing the number of satellites by optimally sharing the radio access between traditional beamforming and multiuse MIMO (SDM).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the plan/elevation view of one embodiment of a fractionated satellite cluster of the system of the present invention.

FIG. 2 shows a 3D view of the satellite cluster of the system of the present invention.

FIG. 3 shows an example of closely spaced user equipment (UEs) on the ground that could be supported by the system of the present invention.

FIG. 4 shows an example of widely spaced user equipment (UEs) on the ground that could be supported by the system of the present invention.

FIG. 5 shows the architecture of a wireless communication system of the system of the present invention.

FIG. 6 shows an example of the segmentation of the coverage footprint of a LEO satellite into traditional beams.

FIG. 7 shows one embodiment of the system architecture of a hybrid processing system, incorporating both traditional beamforming and multiuser MIMO (MU MIMO) in the system of the present invention.

FIG. 8 shows a block diagram of the main satellite of the system of the present invention.

FIG. 9 shows a block diagram of the ancillary satellite of the system of the present invention.

FIG. 10 shows the technical approach of the return link beamforming used in the system of the present invention.

FIG. 11 shows the technical approach of the forward link beamforming used in the system of the present invention.

FIG. 12 shows the technical approach of the forward link channel estimation performed in the system of the present invention.

FIG. 13 shows a system block diagram of the forward link channel estimation performed in the system of the present invention.

FIG. 14 shows a first view of an uplink air interface design according to the present invention disclosure.

FIG. 15 shows a second view of an uplink air interface design according to the present invention disclosure.

FIG. 16 shows a third view of an uplink air interface design according to the present invention disclosure.

FIG. 17 shows a fourth view of an uplink air interface design according to the present invention disclosure.

FIGS. 18A-18G specify the channel coefficient vector estimation methods according to one embodiment (Method A) of the present invention disclosures.

FIGS. 19A-19F specify the channel coefficient vector estimation methods according to one embodiment (Method A) of the present invention disclosures.

FIG. 20 shows key performance indicator (KPI) results for an aspect of the present disclosure (frequency extrapolation of the channel coefficient vector)

FIG. 21 shows a first view of a downlink air interface design according to the present invention disclosure.

FIG. 22 shows a second view of a downlink air interface design according to the present invention disclosure.

FIG. 23 shows uplink and downlink key performance indicator (KPI) results for closely spaced UEs according to the present invention disclosure.

FIG. 24 shows an example of Earth-satellite geometry according to the present invention disclosure.

FIG. 25 shows the relationship (F) between nadir angle (θ) and central angle (ϕ) according to the present invention disclosure.

FIG. 26 shows the rate of change of nadir angle (θ) versus the central angle (ϕ) according to the present invention disclosure.

FIG. 27 shows a simple example of a propagation scenario according to the present invention disclosure.

FIG. 28 shows two examples of propagation geometries according to the present invention disclosure.

FIG. 29 shows examples of variations of the phase of the normalized channel coefficient vector with time, according to the present invention disclosure.

FIG. 30 shows the variation of the phase of the normalized channel coefficient vector with time and frequency, according to the present invention disclosure.

FIG. 31 illustrates a MIMO propagation scenario according to the present invention disclosure.

FIG. 32 provides an artist's rendering of typical spectra obtained by correlating a local pilot signal with the full-bandwidth uplink received signal and then taking its Fourier Transform, according to the present invention disclosure.

### DETAILED DESCRIPTION

### System Architecture

The Reference System is the platform upon which the innovations of the present disclosure are developed as particular enhancements. An overview of that platform is provided first as background. Innovations that support the present claims are described subsequently.

One embodiment of the Reference System is described as follows. It comprised a fractionated, Low Earth Orbit (LEO), satellite network at 800 MHZ, with the specifications in Table 2.1.

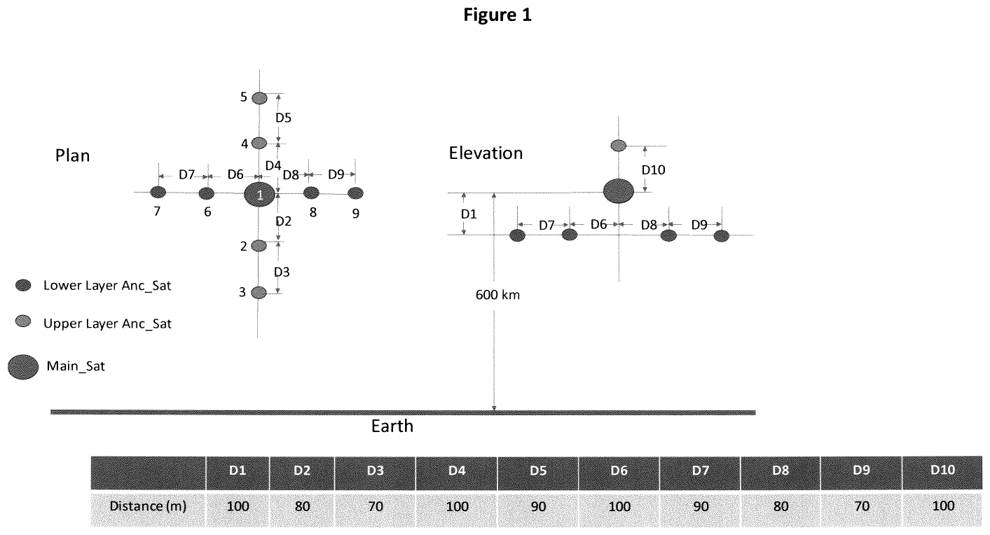

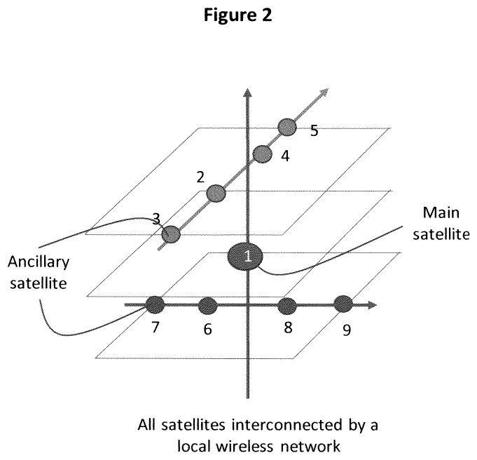

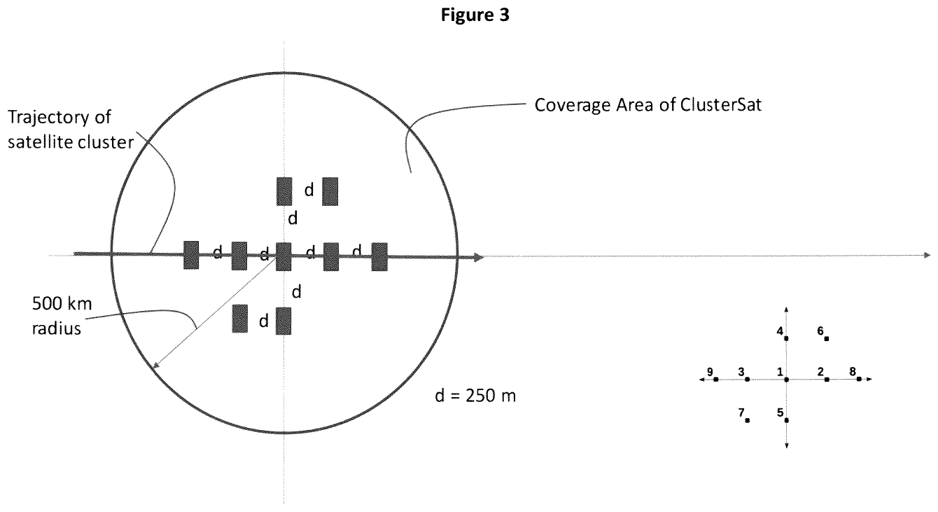

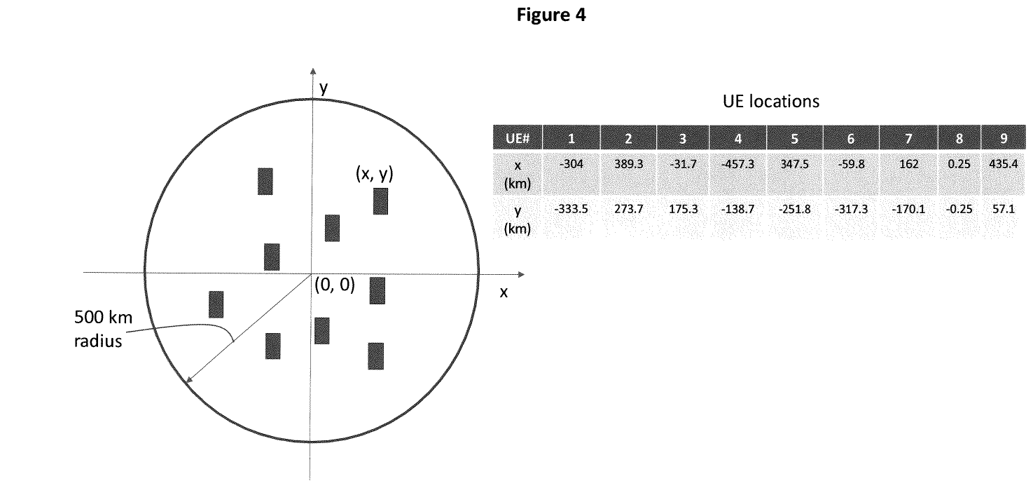

TABLE 2.1
Example Specifications of an example system

| | |
|---|---|
| Operating frequency | 800 MHZ |
| Channel bandwidths | 180 kHz and 1.08 MHz (corresponding |
| | approximately to 3GPP NB IOT and |
| | LTE-M) |
| Number of satellites | 9 (1 main and 8 ancillary) |
| Satellite constellation: | Shown in FIGS. 1, 2 |
| UE distribution | Shown in FIGS. 3, 4 |
| Minimum UE separation | 250 m |
| Number of UEs operating simultaneously with | Variable (as indicated in simulation |
| full-bandwidth reuse (via spatial multiplexing) | experiments) |
| Constellation height above ground | 600 km |
| Minimum elevation supported from UE to | 45° |
| constellation | |
| Maximum elevation supported from UE to | 0° (overhead) |
| constellation | |
| Projected footprint on the ground | Circle with 500 km radius |
| Velocity of constellation (tangential to the orbit) | 7.5566 km/s |

A fundamental attribute of a fractionated satellite is the ability to increase the satellite's antenna aperture by causing the cluster of satellites to form a phased array antenna in space, illustrated in FIGS. 1 and 2. The satellite constellation covers an approximately 400 m×400 m area in the horizontal plane and has a height of approximately 200 m. FIGS. 3 and 4 show typical user equipment (UE) distributions on the ground for Close and Wide spacings.

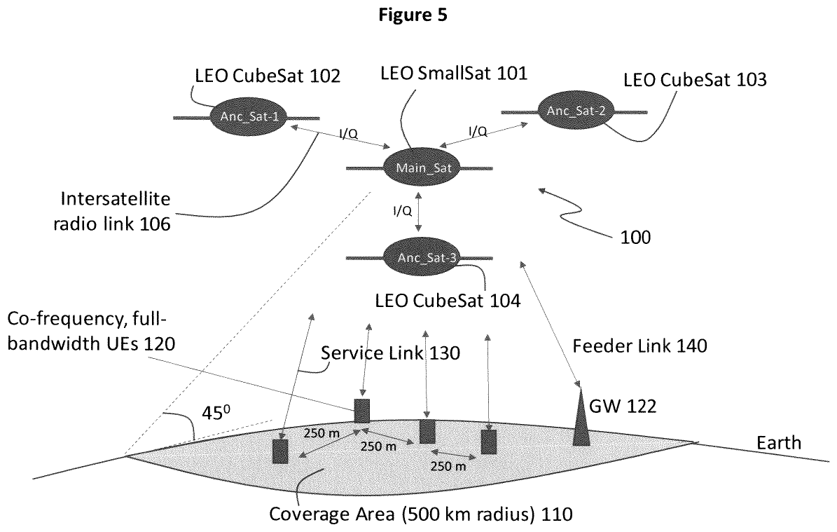

FIG. 5 shows the general system architecture 100 of the satellite cluster. It comprises a main satellite, referred to as Main_Sat 101, which may be a small LEO satellite. It is surrounded by a cluster of ancillary small satellites, referred to as Anc_Sat-1 102, Anc_Sat-2 103 and Anc_Sat-3 104. The ancillary satellites may be substantially smaller than the main satellite, possibly belonging to CubeSat or NanoSat categories. Size and cost reduction of the ancillary satellites is enabled by allocating most of the processing functions—digital and RF—to the main satellite. This reduces the roles of the ancillary satellites to remote antennas/transceivers with a relatively small amounts of digital processing.

The cluster of satellites comprising the fractionated satellite occupy a three-dimensional polyhedron in space. The larger the volume of the polyhedron, the greater is the spatial resolution with which UEs can be accessed, because a larger polyhedron creates a larger effective array aperture.

The cluster of satellites 100, comprising the fractionated satellite, moves in a chosen orbit around the Earth. Many different orbits are known in the prior art for LEOs, including circular, elliptical, polar, and others. The specific orbit is not relevant to the concepts utilized by the system—the teachings are applicable to all LEO constellations. As the cluster moves over the face of the Earth, UEs are handed over between different clusters, or fractionated satellites, using, for example, prior art beam management techniques standardized in 3GPP NTN.

It is not necessary that the satellite separations within the fractionated satellite be identical. The minimum separation distance between UEs depends on the aperture of the satellite cluster and the system design. The UE separation illustrated in FIG. 5 (250 m) is shown to be achievable in simulations. No specific requirements exist for the patterns of the individual satellite antennas, beyond reasonable gains in the directions of interest, i.e. in all directions corresponding to the coverage area 110.

One embodiment of a system architecture, following the Reference System, is shown in FIG. 5. Here, a single spotbeam may cover the entire targeted coverage area 110. The coverage area is usually chosen to be an area on the surface of the Earth from where the elevation angle subtended to the center of the cluster is at least, approximately 45 degrees, as shown in FIG. 5. This minimum elevation angle is usually chosen so that typical blockages are cleared in most environments, except dense urban. Higher elevation angles also ensure a higher Rician K-factor (carrier-to-multipath ratio).

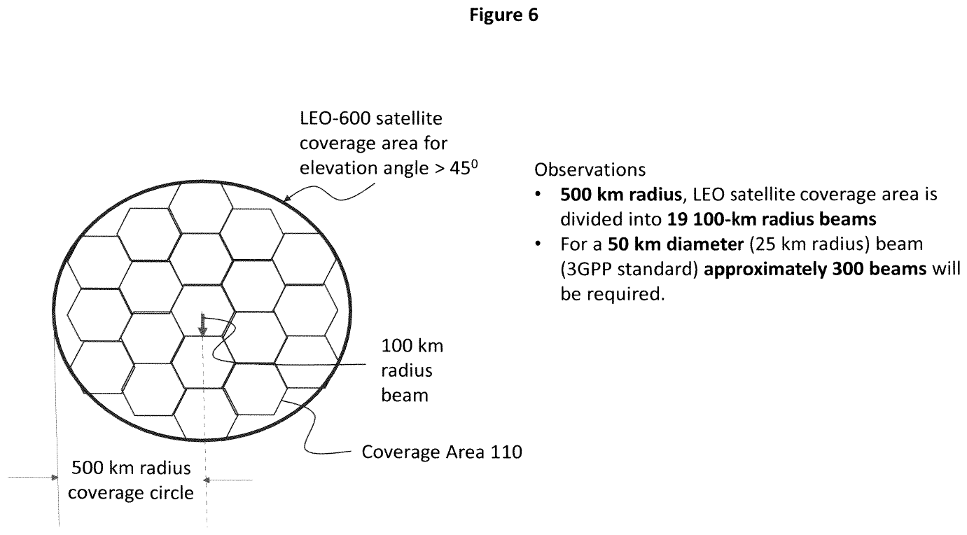

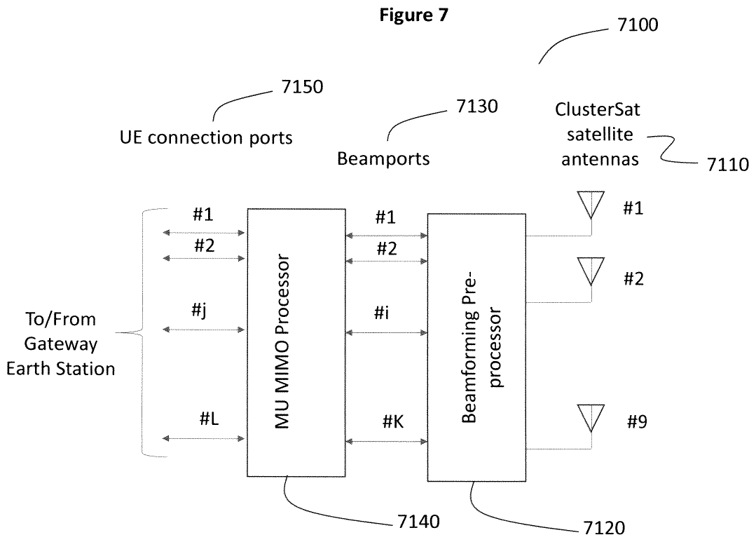

A second embodiment of a system architecture, disclosed here as new art over the Reference System, is illustrated in FIGS. 6 and 7. It involves a hybrid radio access technique, involving both beamforming and MU MIMO. The hybrid radio access technique is discussed under Hybrid Architecture.

### Signal Flow Among Satellites

For the service downlink, the complex signals to be transmitted by all satellites, main and ancillary, are created by Main_Sat 101. The complex baseband (I/Q) signal for each ancillary satellite is communicated to that satellite by the main satellite, together with a GPS time stamp (GPST), over an intersatellite radio link 106. The GPST indicates the scheduled time of downlink transmission, selected by a Scheduler in the main satellite. Techniques for intersatellite communication are known in the prior art and are not discussed here. The downlink signals are transmitted by all satellites at the scheduled GPST. This process ensures that signals transmitted from all satellite antennas are time synchronized, and therefore coherent. Maintaining coherence among all satellites in the cluster is a fundamental requirement.

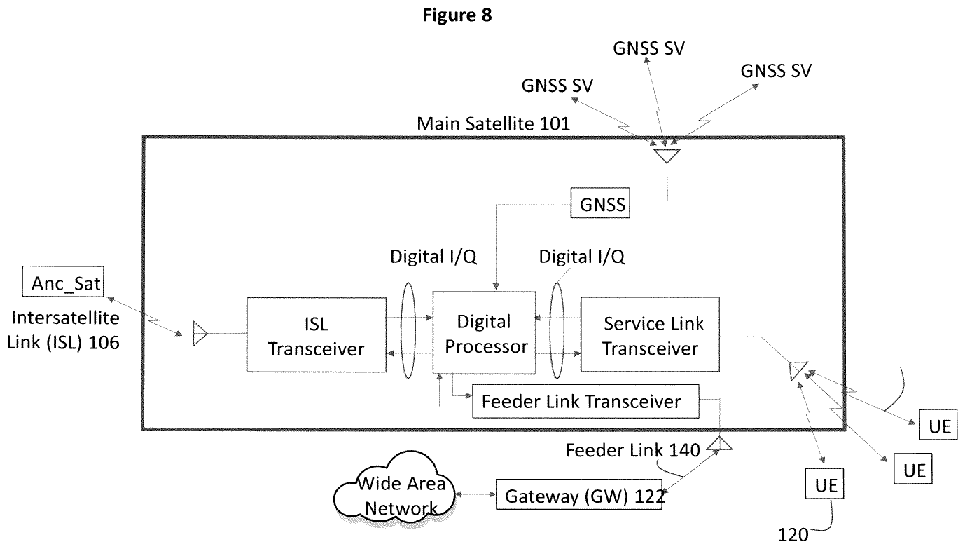

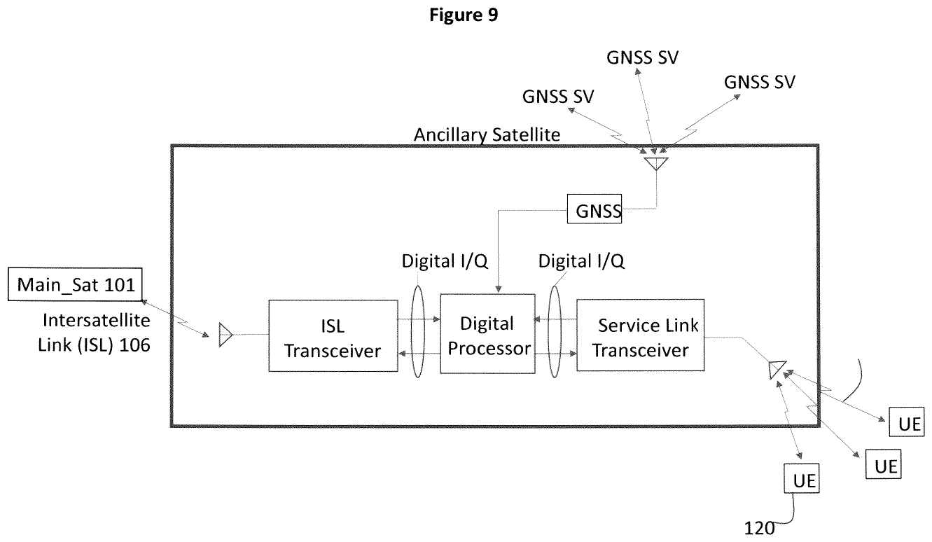

For the service uplink, the signal flow is reversed relative to the downlink. Uplink signals received by the individual satellites (ancillary and main) are downconverted to complex baseband and sent to the main satellite for processing. If the signal was received by an ancillary satellite, the signal is sent from the ancillary satellite to the main satellite over an intersatellite link. The signal packets are accompanied with a GPST, indicating the time of arrival of the packet at the receiving satellite antenna. At the main satellite, the signals received from the ancillary satellites and the main satellite are time aligned and subjected to synthetic beamforming according to chosen SDM algorithms described below. Block diagrams of the processing performed at the main and ancillary satellites are shown in FIGS. 8 and 9, respectively.

### Main Satellite

The architecture of the main satellite is described in FIG. 8. Where the subsystems can be implemented based on prior art, detailed descriptions are omitted. The main satellite, Main_Sat 101, supports the following radio links: intersatellite link (ISL) 106 to a plurality of ancillary satellites, Anc_Sats 102, 103, 104; service link 130 to UEs 120; feeder link 140 to Gateway (GW) 122. The main satellite performs the following functions in the indicated subsystems:

### Digital Processor

The following are the main functions of the Digital Processor of the main satellite.
Uplink and downlink beamforming for each satellite, including itself. The beamforming is a part of the physical (PHY) layer of the service link protocol.
Execution of the full, service link protocol stack, up to the interface with the application layer.
Execution of the full, feeder link protocol stack. The feeder link connects the main satellite to one or more terrestrial, wide area networks through a plurality of gateways (GWs) 122 on the Earth. Use of space-based gateways, hosted on other satellites, is also possible.
Radio resource allocation through an intelligent Scheduler function. This function is similar to those found in Earth-based, cellular base station subsystems' RAN Schedulers.
Execution of interface protocols to the core network. This is similar to those found in Earth-based, cellular base station subsystems' core network interface. In some embodiments, the entire core network may be part of the GW, in which case the core network interface is implemented over the feeder link. In other embodiments, some core network functions, such as the service gateway (S-GW) in LTE networks, may be performed in the main satellite. The partitioning of the core network between implementation in the main satellite and in the GW 122 is not material to the CONOPS of ClusterSat.
Applying GPST time stamps to message packets sent to the ancillary satellites, and consuming GPST time stamps applied to message packets received from the ancillary satellites and by the main satellite's own antenna/transceiver subsystem.
Beamforming for the feeder link antenna. The beamforming may be fixed, or adaptively track the gateway location, as further discussed below.

### Service Link Transceiver

The Service Link Transceiver frequency translates complex baseband (digital I/Q) signals from the Digital Processor to RF and vice versa, the RF signals being transported to a plurality of UEs 120 over service link 130.

The access protocol used on the Service Link 130 may be based on a cellular standard, such as LTE or 5G, modified to accommodate the ClusterSat-specific requirements. A motivation of alignment with a 3GPP standard may be the scale of the components using the standard. However, reusing a terrestrial protocol for satellite, which has different channel characteristics, often results in a suboptimal air interface form power and/or spectrum efficiency perspective. An example access protocol, or air interface, optimized for satellite MIMO and containing several innovations, is disclosed under Air Interface Definition.

### Feeder Link Transceiver

The feeder link 140 connects the main satellite 101 to a gateway (GW) station 122 on the Earth. The purpose of the gateway is to provide connectivity to terrestrial wide area networks such as the Internet or Mobile Network Operators' (MNO's) core networks.

### Ancillary Satellite

The ancillary satellite architecture is described at a high level in FIG. 9. Where the subsystems can be implemented based on prior art, detailed descriptions are omitted. As the architectures of the main and ancillary satellites are similar, only the differences between the two are explained below.

### Digital Processor

Below is a discussion of the main functions of the Digital Processor of the ancillary satellite.

Preferably, all beam-weight calculations and the creation of service link signals are performed by the main satellite. Except for providing and consuming GPST time stamps as described above, the ancillary satellites act as pass-through channels for service link signals that are developed wholly in the main satellite, for both the downlinks and uplinks. The above complexity reduction enables cost and size reduction of the ancillary satellites. As the ancillary satellites are more numerous than the main satellite, the beneficial impact on the system cost of the above partitioning is substantial.

In the service downlink, as described above, complex-baseband service link signals are transmitted by the main satellite and received by the ancillary satellite. The signals are sent as discrete packets of digital I/Q data on the ISL 106, together with a time stamp corresponding to a scheduled transmit time of the packet by the satellite. The scheduling is performed by the main satellite, using knowledge of the maximum transit time in the ISL, the processing time required by the ancillary satellites, and allowing for some margin.

In the uplink, complex-baseband values of the signal received from the Service Link Transceiver are arranged in packets and time stamped by the ancillary satellite with the GPST corresponding to the time of arrival of the packet as the satellite antenna. The main satellite's Digital Processor processes the signals received from all satellites, including itself, after time aligning them based on the above time stamps.

### Service Link Beamforming

### Return Link Beamforming

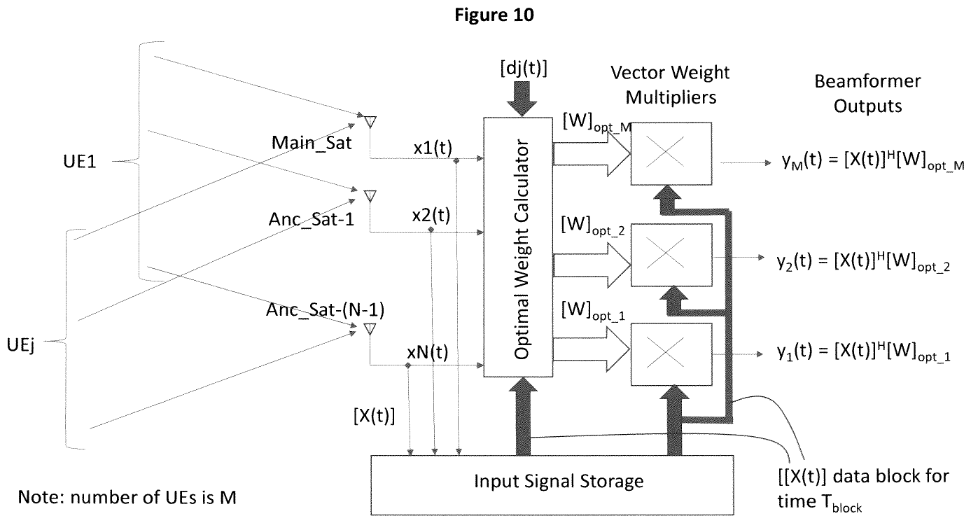

FIG. 10 shows a block diagram representing the return link (UE to satellite) beamforming approach for embodiments using exclusively MIMO as the radio access technology. Where both MIMO and beamforming are used, a beamforming Pre-processor may be included between the antenna array and the Optimal Weight Calculator, as illustrated in FIG. 7 and discussed under Hybrid architecture.

All signals are represented in complex-baseband form, i.e. digital I/Q signals with a center frequency of 0 Hz. The signal processing problem is formulated as follows.

At the UE transmitter, the complex modulation envelope of UEj is sj(t), where the index j identifies the UE and can take values between 1 and M. The signal sj(t) comprises the user information, Uj(t), plus an additive embedded pilot signal, dj(t), as follows.

$$s j ( t ) = U j ( t ) + d j ( t )$$

where dj(t) is a unique waveform, or pilot signal, assigned to UEj and known systemwide. Uj(t) carries user information.

The signals received from the M UEs at the N satellites can be represented as M column vectors, as shown below.

$$\begin{matrix}[ X 1 ( t ) ] = {[ x 11 ( t ) , x 21 ( t ) , … x N 1 ( t ) ]}^{T} \\ [ X 2 ( t ) ] = {[ x 12 ( t ) , x 22 ( t ) , … xN 2 ( t ) ]}^{T} \\ \cdot \\ \cdot \\ \cdot \\ [ XM ( t ) ] = {[ x 1 M ( t ) , x 2 M ( t ) , … xNM ( t ) ]}^{T}\end{matrix}$$

where xij(t) represents the signal received from the j-th UE by the i-th satellite, [Xj(t)] is the N-element input vector from the j-th UE, and T represents transpose of the matrix.

As the signals from the M UEs add linearly at the N satellites' antennas, we can represent the composite received vector, [X(t)], as the sum of the vectors, [Xj(t)], j=1 to M.

$$[ X ( t ) ] = [ X 1 ( t ) ] + [ X 2 ( t ) ] + … + [ X j ( t ) ] + \text{…} + [ X M ( t ) ] \qquad ( 1 )$$

The heart of the beamformer is the Optimal Weight Calculator. The Weight Calculator processes time-blocks of [X(t)], and locally generated & synchronized copies of the UE pilot signals, dj(t), according to an optimization algorithm described below. The algorithm produces M complex weight vectors, [W]_{opt_j}, one for each UE. Each [W]_{opt_j} is optimal for a specific UEj and for a specific time block. Then, a set of scalar outputs, yⱼ(t), (one for each UE) is produced by forming the inner products of the vectors, [X(t)] and [W]_{opt_j}. Tblock is referred to as “coherence time” or “coherence block”, which is a key parameter for the system. Blocks of [X(t)] data are collected in the Input Signal Storage module shown in FIG. 10. The outputs, yj(t) are developed by the following equation.

$${y}_{j} ( t ) = {[ W ( i , j ) ]}_{o p t}^{T} . [ X ( t ) ] \qquad ( 2 )$$

where [W(i,j)]^{T}ₒₚₜ represents the optimum weight for the j-th UE during the i-th T_{block}. Note that yⱼ(t) and [X(t)] are relatively “continuous” variables of time, changing at the input-signal sampling rate; in contrast, [W]ₒₚₜ changes at the periodicity of T_{block}.

As mentioned above, [W]ₒₚₜ is calculated once every T_{block} seconds, where T_{block} is the period of time over which [Rₓₓ] and [R_{xd}] are averaged, as per equations (3) and (4) below. As depicted in FIG. 10, there are M simultaneous beamforming and output generation operations, as the signals from M UEs are processed in parallel. Various options are available for the optimization method, or algorithm. One of the popular algorithms is Minimum Mean Squared Error (MMSE), also referred to as the Least Mean Squared Error (LMSE) and Wiener-Hopf optimization criterion. It requires implementing the following equations in real time software (typically using digital signal processing technology) in the Digital Processor for each UE. For clarity, the UE index, j, is dropped from equations (3)-(5).

$${R}_{x d} = < {[ X ( t ) ]}^{*} . d ( t ) > \qquad ( 3 )$$

where <⋅> represents time average over time-block, T_{block}.

$$[ {R}_{x x} ] = < {[ X ( t ) ]}^{*} . {[ X ( t ) ]}_{.}^{T} > \qquad ( 4 )$$

$${[ W ]}_{o p t} = {[ {R}_{x x} ]}^{- 1} . [ {R}_{x d} ] \qquad ( 5 )$$

The sequence of operations are as follows. As per equation (3), the [R_{xd}] vector, also referred to as the direction vector as it indicates the direction of the satellite relative to the UE, is formed by time averaging the product of the complex conjugate of each xi(t), i=1 to N, and the locally generated pilot signal, d(t). As per equation (2.4), the rectangular covariance matrix, [Rₓₓ], is formed by taking the outer product of [X(t)] with itself and time averaging every term in the matrix over time, T_{block}.

As per equation (5), the matrix, [Rₓₓ] is inverted and post-multiplied by [R_{xd}] to yield the optimal weight, [W]ₒₚₜ. As per equation (2), the scalar output, yⱼ(t) is formed, which is varying with time at the same sampling rate as xᵢⱼ(t). It is a linearly weighted version (inner product) of [X(t)], weighted by [W]ₒₚₜ, where the weight vector changes every T_{block} seconds. The choice of the block time, T_{block}, must be optimized to maximize the received SNIR. On the one hand, it argues for minimizing T_{block} to minimize the variation of the direction vectors from the satellites to the UEs due to satellite motion and the variation of the signal phase due to residual Doppler; on the other hand it argues for maximizing T_{block} to maximize the averaging of noise power and thereby minimize noise power contribution to SNIR. T_{block} is referred to in the literature as coherence bock as, during this time, the usage scenario is expected to remain effectively stationary. Here, effectively means, ‘from the perspective of the desired performance objective’, also commonly referred to as Key Performance Indicator (KPI). In our system, the KPI is SNIR. The process used to optimize T_{block} in the present system is discussed in detail in Section 4.0.

### Forward Link Beamforming

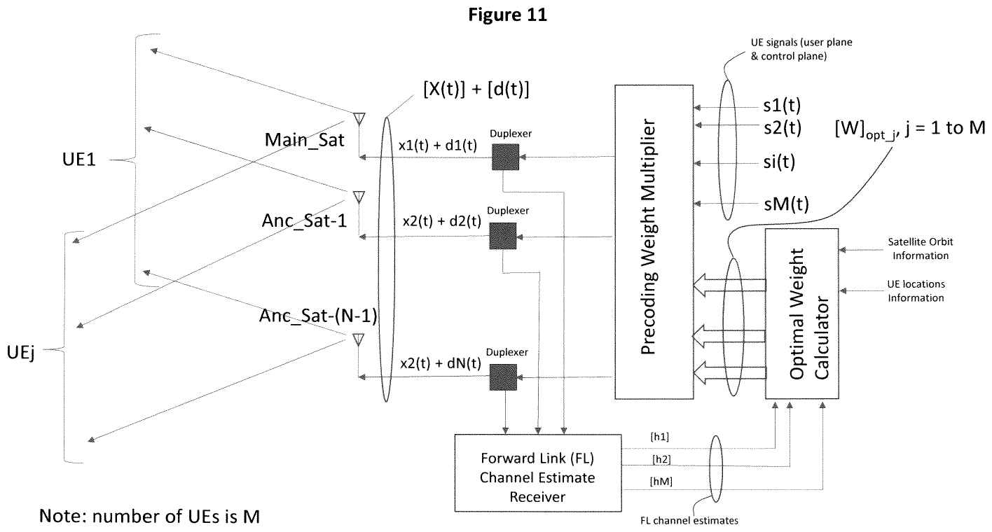

The forward link beamforming approach is illustrated by FIG. 11. The beamforming process involves taking the vector inner-product between [W]ₒₚₜ, which is based on predicted channel states at time, tp, with [X(tp)], which is the vector [X(t)] scheduled for transmission at time, tp. In the literature, downlink [W]ₒₚₜ is often referred to as “precoding weight. Interpreted through the lens of antenna array pattern, optimizing [W]_{opt_j} requires jointly maximizing the magnitude of the gain towards UEⱼ and the minimizing the magnitudes of the gains towards the other cochannel UEs which are being served at the same time.1 ¹ The requirement is stated in terms of the “magnitude” of the gain, because, assuming that the signals transmitted towards the multiplicity of UEs are uncorrelated, the phase response of the antenna pattern created by [W]_{opt_j} is immaterial for maximizing SIR for Uⱼ.

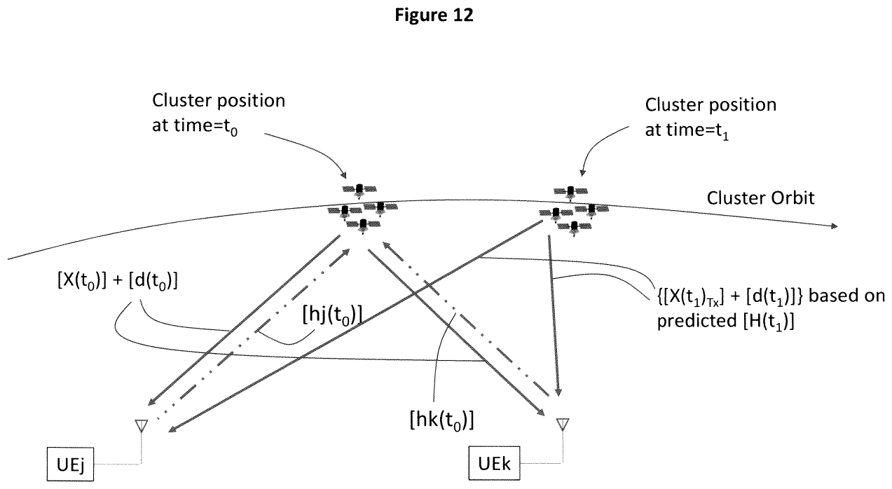

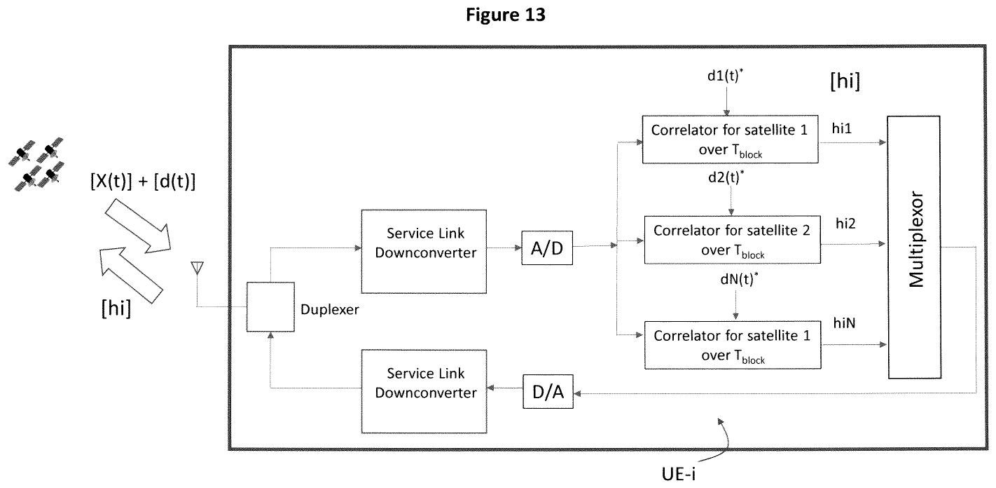

The forward link channel estimation approach is illustrated by FIG. 12. The UE processing system for the same approach is illustrated by FIG. 13. Estimation of the forward link channel is based on unique pilot signals transmitted by each satellite of the cluster. For a given UE, UEⱼ, the channel estimates from the N satellites are received synchronously and used to create a channel coefficient vector, [hj(tᵢ)], where j is the UE index and i is the sampling time index. The channel coefficient vector, also referred to as channel state vector, is estimated by correlating the composite received signal from N satellites with local (reference) copies of the N pilot signals transmitted by the N satellites, as shown in FIG. 13. Note that “correlating” involves the following steps: (i) Doppler removal, (ii) multiplying the received signal with the complex conjugates of the N pilot signals, di (t), and time-averaging the products over the coherence time of the system, T_{block}. This will yield a single sample of the complex, channel state vector [hj(t)], every T_{block} seconds.

An alternative embodiments of UE processing, where the Doppler removal step may be avoided, thereby simplify the processing in the UE, is described later as Method-B.

The channel state vector is tagged with its Frame-of-receipt and fed back by the UE (together with other information such as the time- and frequency-gradient of the channel state vector) to the satellite cluster using the return link. Relative to its use for downlink beamforming, the channel state vector and the associated data will be late by at least the averaging time, T_{block}, plus the Earth-Space propagation time (at least 2 ms for 600 km satellite altitude). More processing delay will be incurred in the main satellite. For 10 ms averaging time and 2 ms propagation time, we would have a latency of at least 12 ms. The beamforming processing and main satellite's scheduling may add another 20-30 ms of latency. Because of time varying Doppler shift, the channel will not remain coherent over such a long period. However, based on ClusterSat's Doppler processing methods (involving time- and frequency-extrapolation of the normalized direction vector), simulations described in Sections 4 and 5, have shown that, for a LOS link with Rician K-factor above 13 dB, the channel state remains sufficiently predictable (although not coherent) to be enable accurate forward prediction of the channel state vector. Leveraging this is one of the innovations of ClusterSat. Process summary: ClusterSat performs continuous, forward-link, channel state prediction from intermittent channel state estimations performed by the UEs and fed back to the satellite cluster. This is a key innovation of the ClusterSat system.

### Forward Link Channel Estimation

Forward link channel estimation may be performed as described in the Reference System. The methods described there are fully applicable to the present system.

### Channel State (Channel Coefficient Vector) Prediction (New Art)

Time- and frequency-extrapolation of the channel coefficient vector is performed as enhancements to the Reference System according to the teachings of the present disclosures. These enhancements minimize the pilot signal density in the air interfaces for both the uplink and downlink. The reduced lower pilot signal density leads to greater power- and spectral-efficiency, which is an important advantage for wireless systems, both terrestrial and satellite. The extrapolation process leverages the low multipath component in a satellite channel, which makes it quasi-stochastic, compared to terrestrial wireless which is more stochastic as it is typically based on non-line-of-sight (NLOS) propagation. However, the extrapolation process also requires careful optimization of the channel state observation window, which is captured in the parameter, T_{block}, mentioned above. T_{block} was set to 10 ms in the present embodiment.

The extrapolation process is described below. It leverages several geometrical characteristics of the propagation channel for a 600 km altitude LEO satellite, which are derived mathematically in Appendix I. The key conclusions about the channel are presented below using as KPI, the phase shift Ψ(t), of a given antenna element, i.e. a satellite of the ClusterSat constellation, relative to an arbitrarily selected reference antenna (satellite), which is given the identity #1. In other words, where [Vᵢ]=[Ψ(t)₁, Ψ(t)₂, . . . Ψ(t)_{N}]^{T} where N is the number of satellites and [Vᵢ] represents the direction vector (also referred to as channel coefficient vector) from the satellite cluster towards UEᵢ, where by definition, Ψ(t)₁=0. It is assumed for simplification that all satellite antennas are isotropic—the methods and systems disclosed here are indifferent to the magnitude the antenna gain as long as there is adequate coverage of the location of the UE.

### Key Conclusions Regarding the Behavior of the Channel Coefficient Vector

The following are the main conclusions from Appendix I provided below, where the theory of the time- and frequency-variation of the channel coefficient vector is developed. These are leveraged in the design of the air interface.
1. Ψ(t,f_{c}) varies linearly with the frequency, f_{c}.
2. Over short time periods, e.g. less than T_{block}=10 ms, Ψ is essentially constant, i.e. the direction vector, [Vⱼ], is essentially stationary.
3. Over medium time periods, e.g. 10-100 ms, Ψ is a linear function of time. That is, the direction vector, [Vⱼ], is a linear function of time over periods under 100 ms in the present system.
4. Over still longer periods, y changes non-linearly with time, i.e. d/dt varies with time over the period.

It is shown below how the air interface design exploits the above channel characteristics.

### Air Interface Definition

An air interface is defined below with utilizes the channel state prediction innovations mentioned above. OFDM is the preferred modulation today for a variety of technical and ecosystemic reasons (having been adopted by 3GPP), and is therefore adopted by the present system.

### Uplink Air Interface

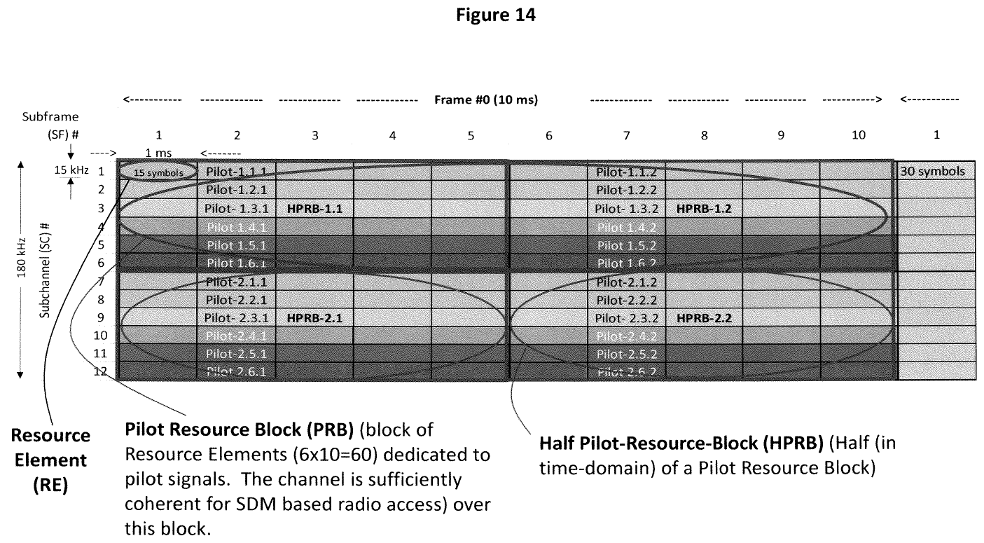

The air interface has a TDM/FDM frame structure shown in FIGS. 14-17. The terms used are defined below.
RE Resource Element: 15 OFDM symbols in a 1 ms subframe, modulated on to a 15 kHz bandwidth subcarrier. For pilot signals, BPSK modulation is used. For traffic signals, QPSK and higher modulations may be used.
PRB: Pilot Resource Block: Block of 60 REs dedicated to 6, frequency-adjacent, OFDM pilot signals occupying 1 Frame in the time domain, i.e. consisting of 10 Subframes.
HPRB: Half Pilot-Resource-Block: Block of 30 REs representing one half of a PRB in the time domain.
TRB: Traffic Resource Block: Block of 60 Resource Elements, dedicated to the transport of traffic signals.

The different colors in FIG. 14 represent different pilot signals. In a PRB, there are 6 pilot signals, which are mutually orthogonal because of OFDM modulation.2 From this structure, the following should be clear: ² Six pilot signals allow up to 6 UEs to be supported simultaneously, co-frequency, by SDM in a 180 KHz bandwidth channel.

In a 180 KHz×10 ms Frame, there are two frequency-adjacent PRBs-PRB #1 and PRB #2. Each PRB comprises two time-adjacent HPRBs-HPRB X.1 and HPRB X.2, where X can be 1 or 2. Consequently, we have 4 HPRBs in the 180 KHz×10 ms Frame shown in FIG. 4.1.1. Of these 4 HPRBs, two (e.g. HPRB X.1, and HPRB X.2) are time-adjacent, and two (e.g. HPRB 1.X and HPRB 2.X) are frequency-adjacent.

Each pilot channel in a HPRB is repeated in the frequency-adjacent HPRB in the same relative, frequency-position. For example, Pilots 1.1.1 and 2.1.1 carry identical data, are assigned to the same UE, and are separated by 90 KHz.

PRBs have a bandwidth of 90 kHz. In the present, example design, the signals were found to be sufficiently coherent, for adaptive array processing, over a bandwidth of 90 KHz. This is referred to as the coherent bandwidth of the array. This means that the optimum weight determined using any pilot in the 90 kHz block could be used for any frequency in the block—the weight can be frequency independent within the coherent block.

Thus, in the 180 KHz channel bandwidth shown, up to 6 UEs can transmit simultaneously via SDM, each using the full 180 kHz of bandwidth. In other words, up to 6 UEs can share TRB-1 and TRB-2 in FIG. 4.1.2. This can be scaled to greater numbers of UEs by increasing the channel bandwidth beyond 180 kHz, causing the PRB to extend over a larger bandwidth, such as 1080 MHz. In the limit, 36 UEs could be supported simultaneously over a bandwidth of 1080 MHz; however, the number of satellites would have to be scaled from the present 9 to approximately 54, unless the Hybrid Architecture, mentioned above, was used to limit the number of UEs separated by MU MIMO to a value smaller than 54.

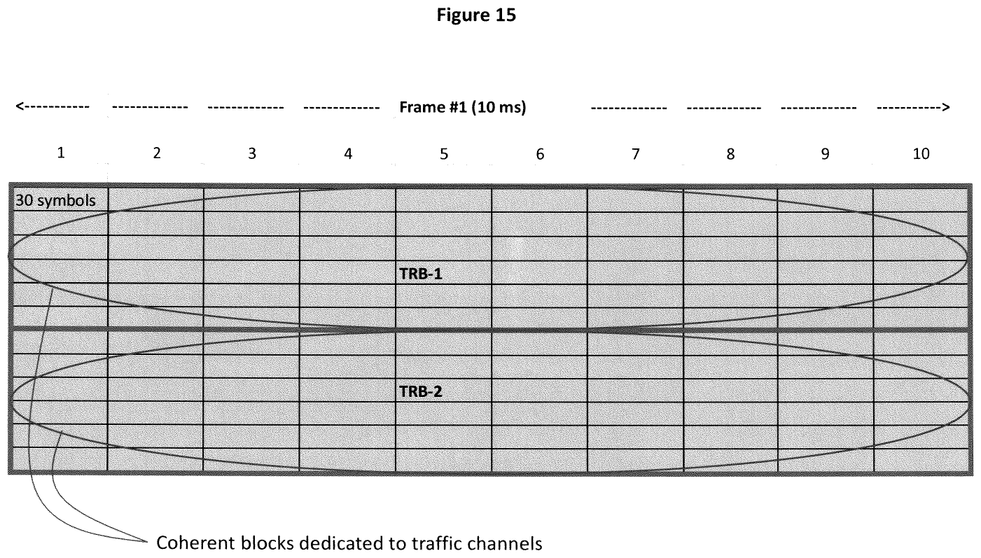

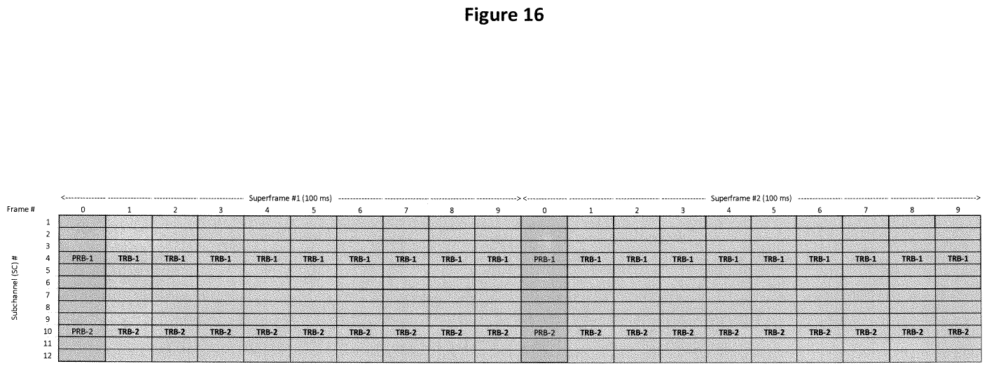

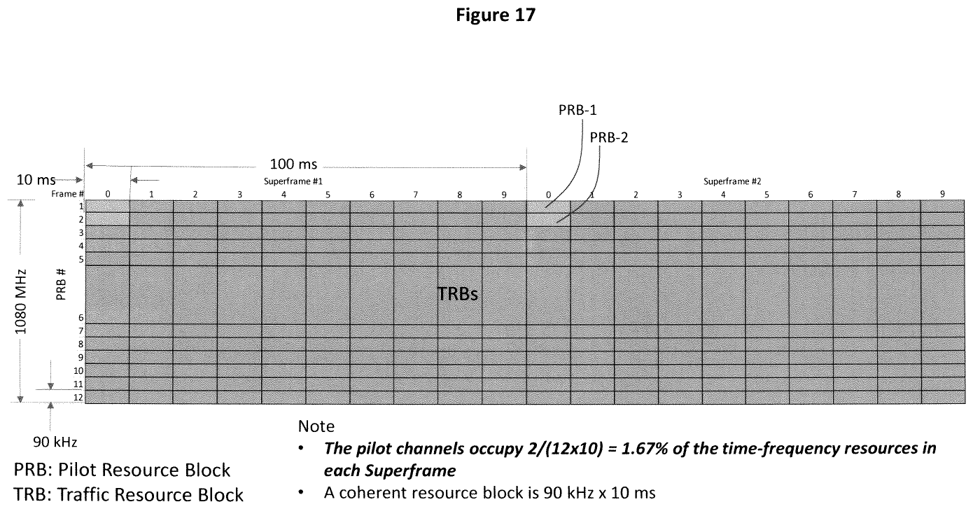

FIG. 14 shows the 1st Frame of a 10-frame Super-Frame and is dedicated exclusively to pilot signals. FIG. 14 shows that, following the 1st Frame, the subsequent 9 Frames are dedicated to traffic signals, and are completely pilot signal free. FIG. 15 shows a non-pilot bearing Frame, such as Frame #1. Such Frames can be filled exclusively by traffic bearing REs, and the entire Frame comprises two TRBs (Traffic Resource Blocks), one for each PRB. FIG. 16 shows the big picture relationship between Resource Elements, Frames and Super-Frames. FIG. 17 shows the case of a channel bandwidth exceeding 180 kHz. Here Frame #0 does not include any pilot signal transmission—the REs corresponding to PRBs>#2 in Frame #0 are designated TRBs, thereby increasing the traffic capacity. In this case, frequency-extrapolation of the channel coefficient vector is used to determine the optimal weights for PRBs greater than 2.

Note that the PRB—i.e. the epoch when pilot signals are transmitted by the UE—repeats once in every ten Frames (100 ms). This may suggest that 10% of the spectral resources need to be dedicated to pilot signals. This is true for a 180 kHz channel but not true for higher bandwidth channels, such as a 1080 MHz bandwidth channel (assuming 6 simultaneous UEs), where the overhead is reduced to (2/120=1.67%) by frequency extrapolation of the channel coefficients.

### Channel Coefficient (or Direction) Vector Estimation.

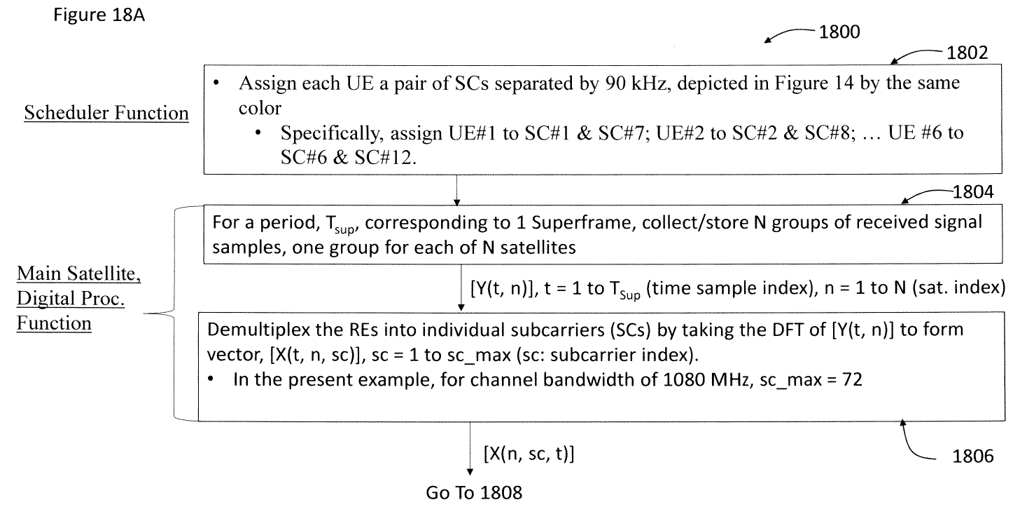

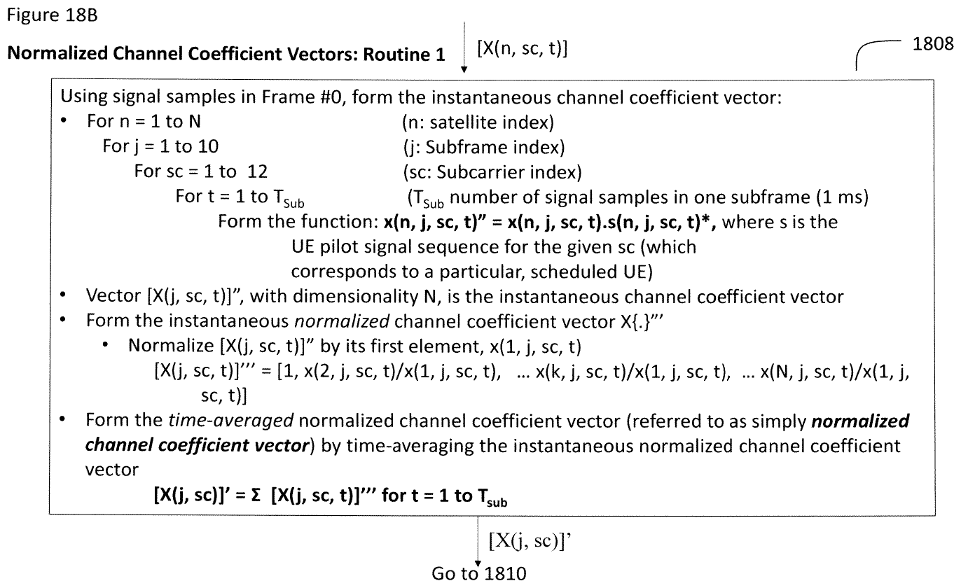

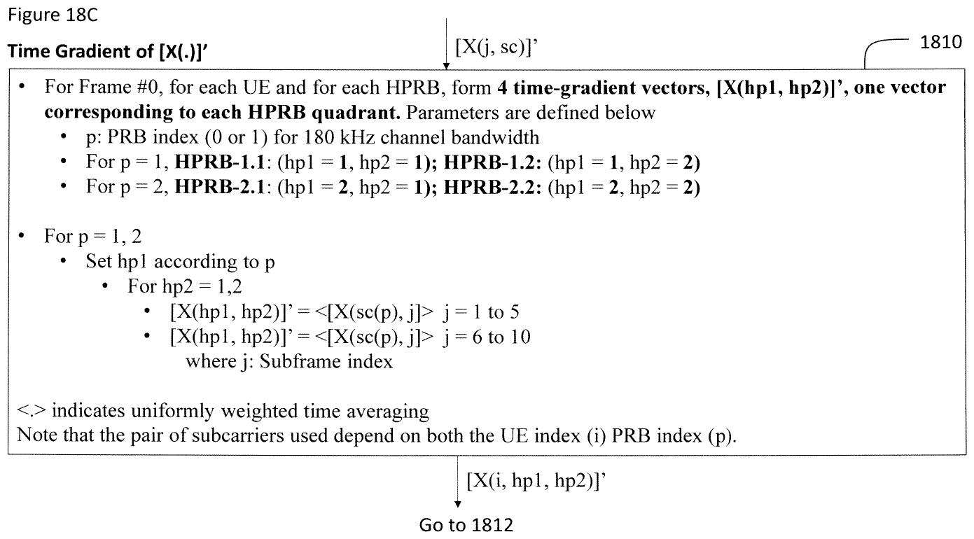

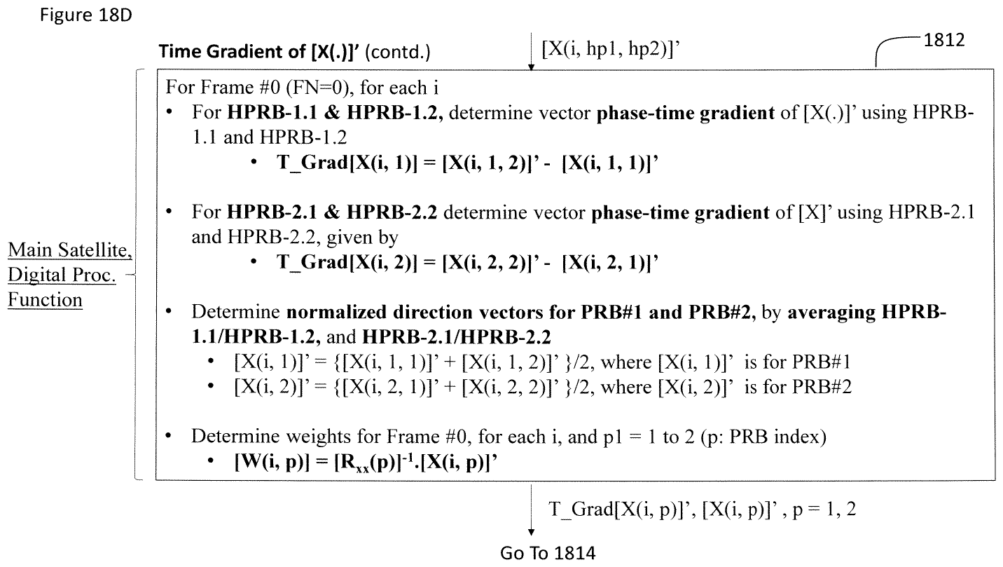

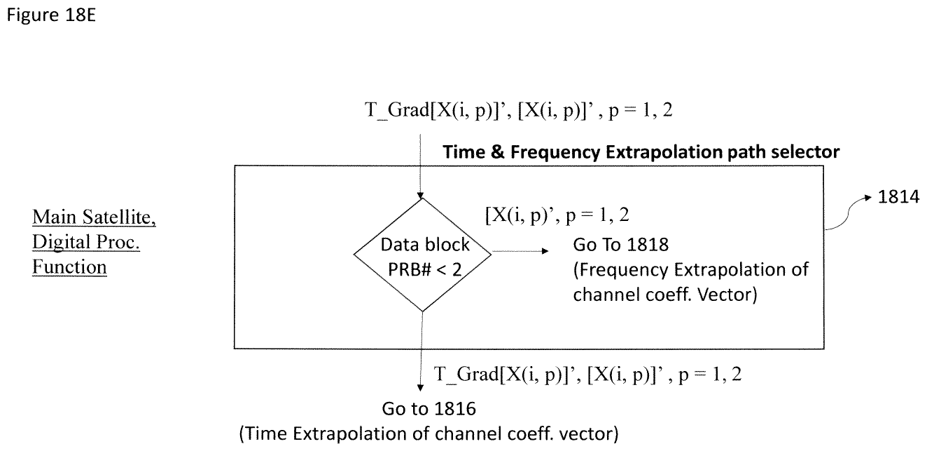

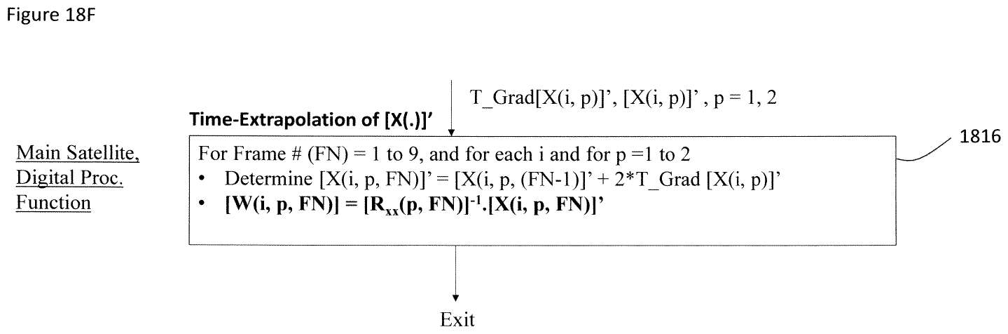

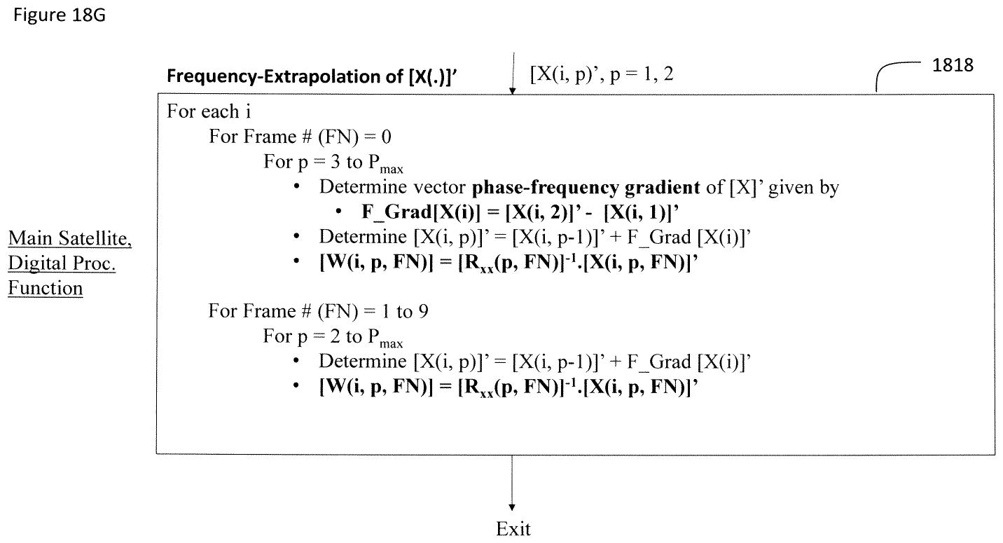

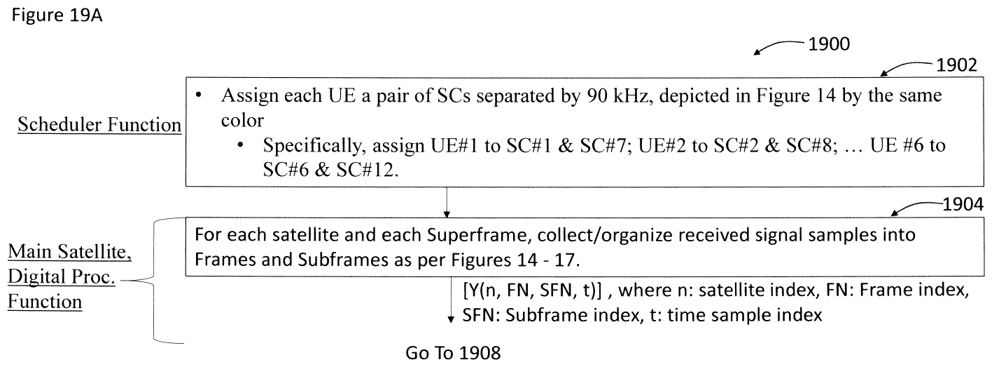

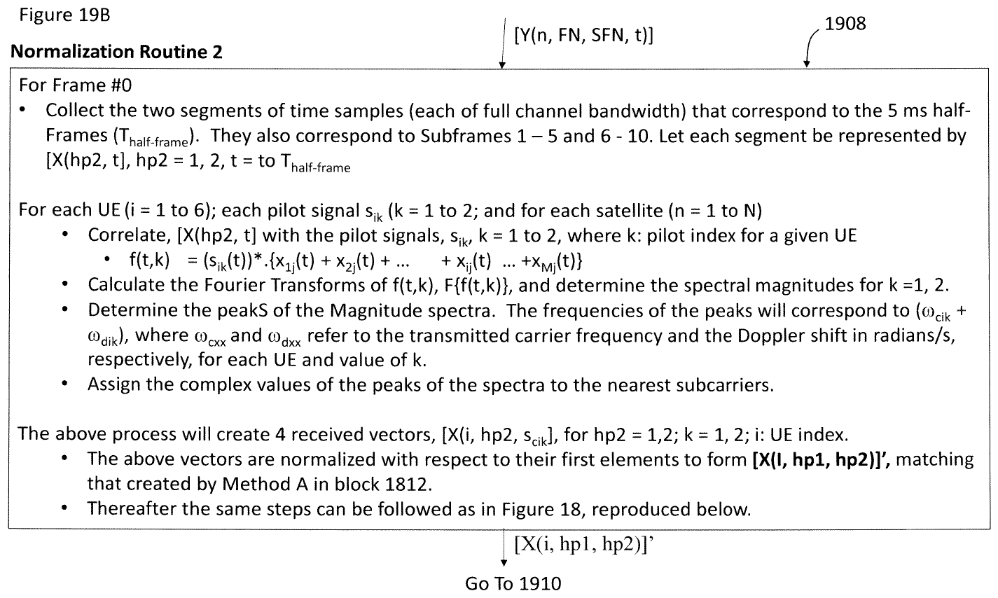

One embodiment for channel coefficient vector estimation, referred to as Method A, is specified in FIGS. 18A-18G and explained below.

The subsystem 1800, shown in FIG. 18A, may be implemented by a combination of hardware and software. The functional block 1802 is typically performed in the Scheduler function of the Radio Access Network (RAN). This may be realized in the present system either in the Main Satellite 101's Digital Processor or a Gateway (GW) 122 on the ground (both shown in FIG. 8. The Scheduler assigns each UE a pair of subcarriers (SCs) separated by 90 kHz and depicted with the same color in FIG. 14. A frequency separation of 90 kHz is chosen because 90 kHz is the coherent bandwidth of the phased array antenna formed by the fractionated satellite. During Frame #0, each UE transmits a unique, pseudo-random modulation waveform with identifies the UE. In one embodiment, it may have BPSK modulation produced by a Gold code-sequence. The same or different sequences may be used for the two pilot carriers assigned to a given UE.

The Digital Processor of the Main Satellite 101 performs the remaining operations required for channel coefficient vector and optimal weight estimation. The details are described below.

In block 1802, complex baseband I and Q signal samples, received from N satellite antennas are stored as N separate groups or vectors, [X(t)]. The vectors are further organized as time-domain frames, as per FIGS. 14-17. The framing boundaries are known as the uplink transmissions are synchronized to the network time. The UEs may be required to advance the timings of their transmissions to achieve this synchronization—this may be done using prior art 3GPP NTN standards [3GPP TR 38.821].

In block 1806, the signal samples in the Superframe are channelized into 12 subcarriers by OFDM demodulation. This is typically performed by taking the Discrete Fourier Transform (DFT) of the time samples comprising an OFDM symbol (of 67 microseconds duration for 15 kHz subcarrier channel bandwidth). The outputs of the DFT's (or OFDM subchannels) form a time series represented by x(sc, t), where sc is the subcarrier index and t is the time sample index. When treated as an N-element vector by considering the x(⋅) from N satellites, we have [X(sc, t)], as shown in block 1806.

In block 1808, each signal sample in x(n, j, sc, t), where n is the satellite index and j is the subframe index, is multiplied by the complex-conjugated pilot signal for that subcarrier, s(j, sc, t)*. This results in the instantaneous, channel coefficient, x(n, j, sc, t)″ for each antenna, and the vector [X(j, sc, t)]″. This vector, is normalized to [X(j, sc, t)]′″ by dividing each element by the first element of [X(j, sc, t)]″. The above, instantaneous vector is time averaged over 1 Subframe to form the time-averaged, normalized channel coefficient vector, referred to simply as normalized channel coefficient vector, [X(j, sc)]′.

In block 1810, time-averaging is performed to reduce the initial set of 120 instantaneous, normalized channel coefficient vectors (12 subcarriers, 10 Subframes) to as set of 4 time-averaged vectors. They are identified by time-averaging of the vector performed over the RE-groups identified as HPRB-1.1, HPRB-1.2, HPRB-2.1 and HPRB-2.2 as shown in FIG. 14.

Specifically, for PRB #1, the channel coefficient vector is averaged over Subframes 1-5 to create [X(i, 1,1)]′ and averaged over Subframes 6-10 to create [X(i, 1,2)]′. Similarly, for PRB #2, the channel coefficient vector is averaged over Subframes 1-5 to create [X(i, 2,1)]′ and averaged over Subframes 6-10 to create [X(i, 2, 2)]′. The general expression for the Subframe-averaged channel coefficient vector is [X(i, hp1, hp2]′, for hp1=1, 2 and hp2=1, 2, as shown in FIG. 18C, block 1810.

As shown in FIG. 18D, block 1812, the set of 4 normalized, time-averaged, channel coefficient vectors, [X(i, hp1, hp2]′ is used to generate a time gradient of the channel coefficient vector. It is given by T_Grad [X(i, 1]′ for PRB #1 and T_Grad [X(i, 2]′ for PRB #2. In addition, full-Subframe-averaged estimates of the normalized channel coefficient vectors for PRBs #1 and #2 are also generated, given by [X(i, p)]′, p=1,2.

In FIG. 18E, block 1814, data items, T_Grad [X(i, p)]′ and [X(i, p)]′ are passed to a Time & Frequency Extrapolation path selector. Here a decision is made whether time extrapolation is sufficient to determine the normalized channel coefficient vectors for the remaining REs in the Superframe, if frequency extrapolation was also required. Time extrapolation would suffice if the channel bandwidth was limited to that covered by PRB #1 and #2 (180 kHz in the present embodiment); if the channel bandwidth extended beyond PRB #1 and #2, as shown in FIG. 17, frequency extrapolation will be required in addition to time extrapolation. In the embodiment described here, time extrapolation is performed first to estimate the normalized channel coefficient vectors for PRBs #1 and #2 for Frames 0-9. The normalized channel coefficient vectors for these frames are subsequently, frequency extrapolated to higher PRBs. It is also feasible to perform frequency extrapolation before time extrapolation. For example, frequency extrapolate the normalized channel coefficient vectors for PRB #1 and #2 for Frame #0 and then time extrapolate them to fill the remainder of the Superframe.

The time-extrapolation process is specified in FIG. 18F, block 1816. The process involves linear extrapolation of the normalized channel coefficient vector of a first Frame to an immediately following second Frame using T_Grad [X(i, p)]′ determined in Frame #0. Based on the time-extrapolated normalized channel coefficient vector, the optimal weight yielded by the LMSE algorithm, [W(i, p, FN)]′ is determined.

The frequency extrapolation process is specified in FIG. 18G, block 1818. It involves a similar process of linear interpolation of the normalized, channel coefficient vector in the frequency domain, using the frequency gradient estimated in Frame #0 using PRB #1 and #2. Unlike in the time domain, no frequency domain averaging is performed in estimating the frequency gradient, F_Grad[X(i)]′.

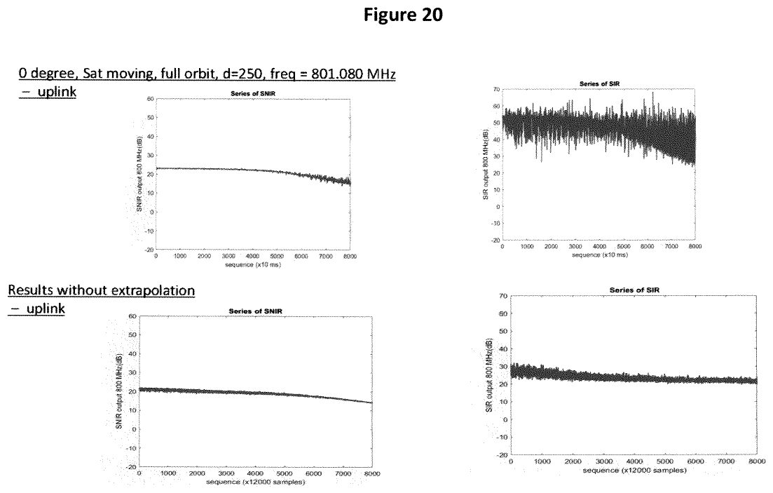

Note that the time-gradient and the frequency-gradient of the normalized channel coefficient vector are assumed to remain unchanged over the 100 ms duration of the Superframe—it is estimated only once every Superframe. Similarly, the frequency-gradient is assumed to be constant over approximately 1 MHz. Both assumptions were validated analytically (c.f. Appendix I) and through simulations, whose results are provided in FIG. 20.

### Uplink Doppler Compensation

The channel coefficient (or direction) vector estimation methods and system described in FIGS. 18A-18G assumes that the received pilot signals maintain their orthogonality at the receiver. Pilot signal contamination, i.e. interference between pilot signals, is a major concern in MIMO systems. Such interference could occur because of adjacent channel interference among the ClusterSat pilot signals through unequal Doppler shifts. It is noteworthy that in an LOS MSS channel, the Doppler shift depends largely on the propagation geometry.³ For a given UE, the Doppler variation among satellites is di minimis owing to the path geometry; however, this does not hold for widely spaced UEs, although expected to be relatively small for closely spaced UEs, such as inside a 50 km diameter beam. It is shown in Table AI.3.1 that the maximum Doppler shift variation between a UE with nadir geometry and one with 45° elevation geometry is approximately 14 kHz. Therefore, it is concluded that the maximum Doppler rate variation over a 500 km footprint of a 600 km altitude LEO will be approximately 2×14=28 kHz. This comprises a frequency offset of approximately two subcarriers, showing that, if no beamforming is used to subdivide the footprint into smaller segments, as described under Hybrid architecture, the inter-subcarrier interference could be significant. ³ This is truer of the direction (or channel coefficient) vectors than individual channel coefficients because, whereas the latter depends only on the time-rate of change of the multipath environment, the former depends on the multipath footprint. Therefore, it possible that, even when the carrier-to-multipath ratio is relatively large, say 6 dB, the Angle-of-Arrival (AoA) variance, which drives the variance of the normalized direction vector, can be relatively small if the multipath footprint is small. This is one of the features leveraged in the present invention disclosure.

3GPP has standardized a method of uplink Doppler pre-compensation whereby the UE-compensates for the Doppler frequency shift. This is based on a priori knowledge of the dynamics of the propagation geometry, i.e. the satellites' locations and velocities and the same for the UE. This information may be furnished by the network to the UE via bulletin board messages, referred to as SIB messages in 3GPP standards; the latter may be estimated by the UE by means of an onboard navigation subsystem. If the uplink Doppler shift is fully compensated, the pilot signals will be received without any adjacent channel interference. In practice, some residual Doppler shift may remain because of imperfect Doppler compensation, which can be removed during demodulation though equalization methods well known in the prior art.

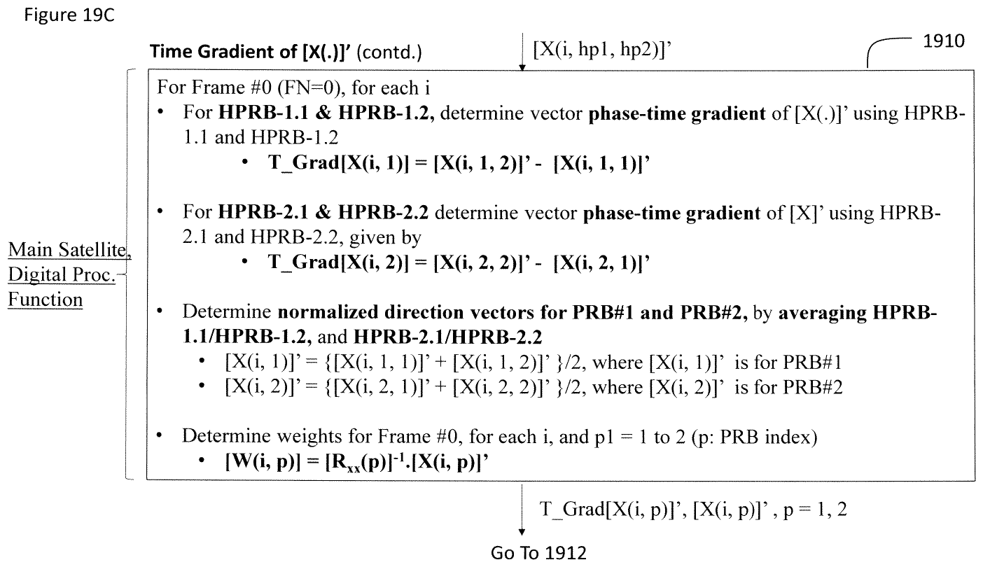

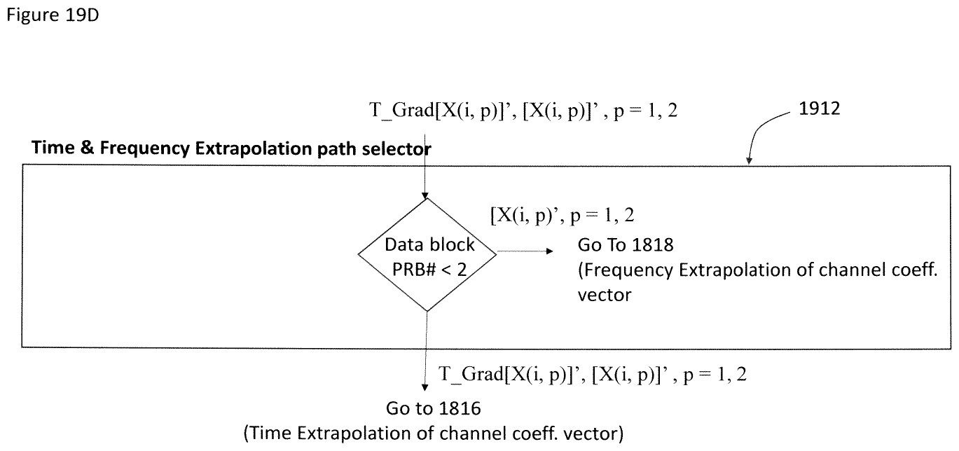

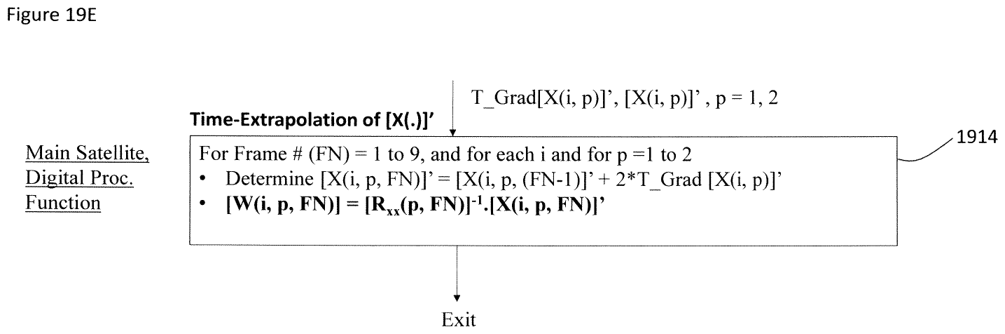

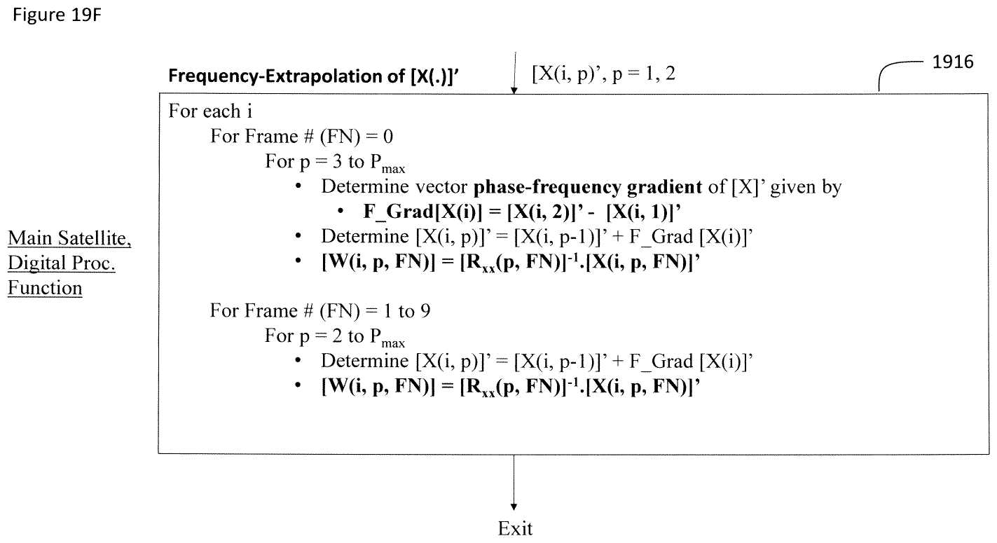

Method A for channel coefficient vector estimation, described in FIGS. 18.1-18.7, may be used with the 3GPP standardized method of UE based Doppler pre-compensation. However, pre-compensation burdens the UE, In cellular, and cellular inspired systems such as the present, it is desirable to bias complexity away from the UE and towards the network, for economic reasons of scale. A new channel coefficient vector estimation method, Method B, which does not burden the UE, proposed here as an alternative method for channel vector estimation. Here, the Doppler frequency offset is post-compensated in the Main Satellite 101. Method B is specified in FIGS. 19A-19F. The analytical basis for Method-B is provided in Appendix-III.

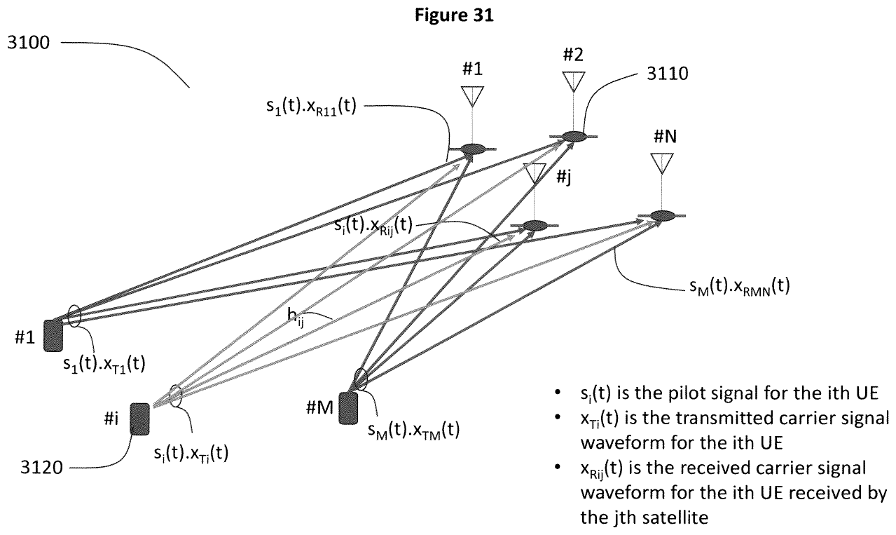

Method B differs from Method A mainly in how the 4 time-averaged, normalized channel coefficient vectors [X(i, hp1, hp2)]′ are generated. As previously, here i is the UE index, and (hp1, hp2) for p=1, 2, indicates the quadrant of Frame #0 that the time-averaged channel coefficient vector is generated. In Method A, a180 kHz bandwidth signal, comprising (up to) 12 15-kHz subcarriers, was first channelized using an OFDM demodulator, which is typically implemented as a DFT process. Channel coefficient vectors were then formed using the outputs of the subchannels, one vector per Subframe. In contrast, in Method B, the full-bandwidth signal is instantaneously correlated (i.e. correlated without time averaging) with a pilot signal corresponding to a UE which is known to have been assigned to Frame #0. This results in the function, f(t,k)=(sᵢₖ(t))*. {x₁ⱼ(t)+x₂ⱼ(t)+ . . . +xᵢⱼ(t) . . . +x_{Mj}(t)} shown in FIG. 19B, block 1908. The Fourier Transform (FT) of the f(t,k), F{f(t,k)}, reveals the actual, received frequency of the pilot signal, as illustrated in FIG. 31. As the FT is taken over the HPRB-P.1 and HPRB-P.2, where P=1 or 2, it is ensured that the time-averaging performed explicitly in Method-A is implicitly present in Method-B. The peak, complex value of the spectrum obtained above represents the time-averaged channel coefficient vector for a given subcarrier in Method-A. The time-averaged channel coefficient vectors are normalized and subsequently processed exactly as in Method-A. Although the rest of the process after determining the time averaged channel coefficient vector are identical for Methods-A and B, the entire process is shown for Method-B in FIGS. 19A-19F.

### Validation of Uplink Channel Prediction Methods

In FIG. 20, the upper SNIR plot is for a pilot signal as 801.080 MHz (PRB #12), which was produced by the frequency extrapolation of the normalized channel coefficient vectors in PRBs #1 and #2 for Frame #0; thereafter, the normalized channel coefficient vectors for PRB #12 and Frames #1-#9 were produced by time-extrapolation using the time-gradients determined in Frame #0. The lower SNIR plot was produced without frequency extrapolation (Frame #0 transmitted pilot signals). The fact that the KPI plots are very similar for both cases is proof of the efficacies of both time- and frequency-extrapolation methods described above (note that case 1 required time extrapolation in addition to frequency extrapolation).

### Downlink Air Interface

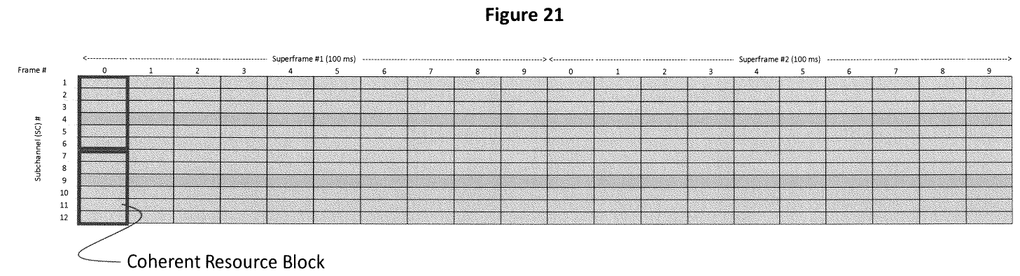

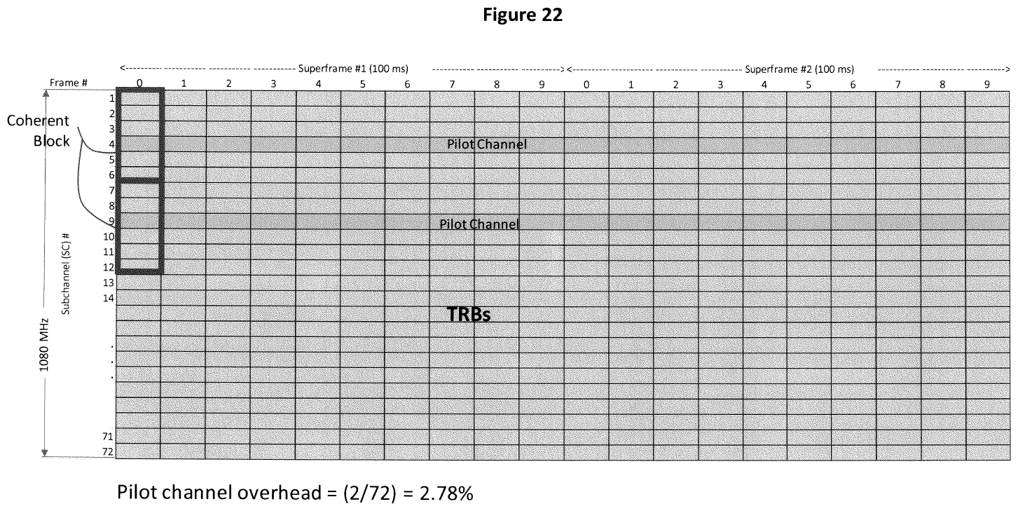

The downlink (DL) air interface frame structure is shown in FIG. 21 for a 180 KHz bandwidth embodiment and FIG. 22 for a 1080 kHz bandwidth embodiment.

### Cochannel Pilot Signals for Different Satellites

In a one embodiment, pilot signals may be transmitted continuously on SC #4 and SC #9, unlike in the uplink where they are time multiplexed with traffic signals. All other Subchannels are dedicated to traffic signals (downlink TRBs). The two pilot channels (SC #4 and SC #9) are shared by the pilot signal modulations of all satellites by code-multiplexing. From a given satellite, the same pilot code is modulated on to the two pilot channels and are used for frequency extrapolating the direction vector to REs other than those occupied by the pilot signals. The concept of coherent resource block applies equally in the downlink as in the uplink and is shown in FIGS. 21 and 22. For example, the same [W]_{opt_j} can be used for all REs within a coherent block. As a pilot signal is present in every Frame, there is no need to time extrapolation. Frequency extrapolation is used to determine the optimal weights for the traffic bearing Subchannels, where pilot signals are absent.

In alternate embodiments, to increase the isolation between pilot signals, the pilot signals may be time multiplexed. In such embodiments, determining optimal weights for Frames carrying no pilot signal may be determined by time-extrapolation the normalized channel coefficient vectors as described in the uplink case.

### Validation of Uplink and Downlink Channel Estimation Methods

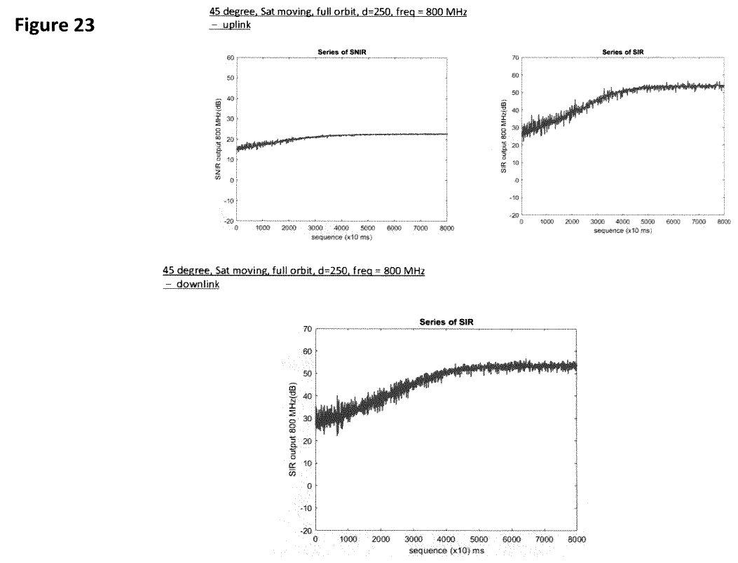

FIG. 23 shows a comparison of the simulation results of uplink and downlink processing. In the latter, the UE estimated downlink channel state vector, [h], was assumed to be identical to the satellite cluster estimated uplink direction vector, [X]′. Error-free execution is assumed of the prior art process described in the Reference System.

### Hybrid Architecture: Combining Beamforming and Multi-Satellite MIMO

It was mentioned above that MU MIMO need not be the only radio access technology deployed by embodiments of the present inventions, and that traditional beamforming and MU MIMO may be deployed together in a hybrid architecture. Details of the hybrid architecture are provided below.

Two UEs at a sufficiently large spatial separation may be provided isolated radio links either by (i) beamforming or by (ii) MU MIMO. Method (i) requires deploying a beam laydown where the UEs desiring spatial isolation must be in separate beams; method (ii) provides spatial isolation by synthesizing an antenna pattern (in the phased-array antenna formed by the fractionated satellite), where a peak of the antenna's radiation pattern points towards the desired UE and a pattern-null points towards the undesired UE. However, in method (ii), the available number of nulls is limited to (N−1), where N is the number of antenna elements. In practice, (N−2) is a more realistic objective. Therefore, when MU MIMO is deployed over a large footprint, the number of simultaneously supportable UEs could be relatively limited. As the strength of MU MIMO is focusing capacity in small areas, while beamforming can cover a large number of UEs but with relatively large spatial separation, it is advantageous to segregate UEs into proximate groups which are assigned to beams and then use MU MIMO to isolate users within the proximate groups. FIGS. 6 and 7 illustrate the hybrid architecture concept.

FIG. 6 shows that the 500-km radius footprint of ClusterSat (defined by an elevation angle>45°) could be divided into approximately 19 100-km diameter beams, or 300 50-km radius beams. The latter represents the present 3GPP reference design for NR NTN Release 17 and uses a 4 m aperture satellite antenna at S-band [3GPP TR 38.821]. If N=3 frequency reuse was used for traditional beamforming, then a 5 MHz channel bandwidth could be reused in a group of 300/3=100 beams. Assuming a 9-satellite ClusterSat satellite then, within each beam, the 5 MHz channel could be reused at last 7 times, and by beamforming the 5 MHz channel could be reused 100 times. This shows that it might be more economical and practical to support 700 users by a combination of beamforming and intra-beam MU MIMO than by MU MIMO alone, which would require deploying approximately 700 satellites. For example, beamforming could be used to serve users within 50 km diameter beams, as per the 3GPP reference design [ibid], and MU MIMO as per the present invention disclosures for up to 7 users simultaneously without resorting to time-or frequency-multiplexing.

FIG. 7 shows a block diagram of the transmit/receive processing subsystem 7100 in a hybrid beamforming/MIMO main satellite in the present architecture. The digital, I and Q samples of the signals received by the satellites 7110 are assembled in the main satellite as described above. There, instead of undergoing MIMO processing immediately, they are processed in a Beamforming Preprocessor 7120, where a subset of received UE signals are selected for MIMO processing in the MU MIMO Processor. The weight determination algorithms of the Beamforming Preprocessor and the MU MIMO Processor can be operated independently.

### Appendix I Theoretical Foundations of Air Interface Design

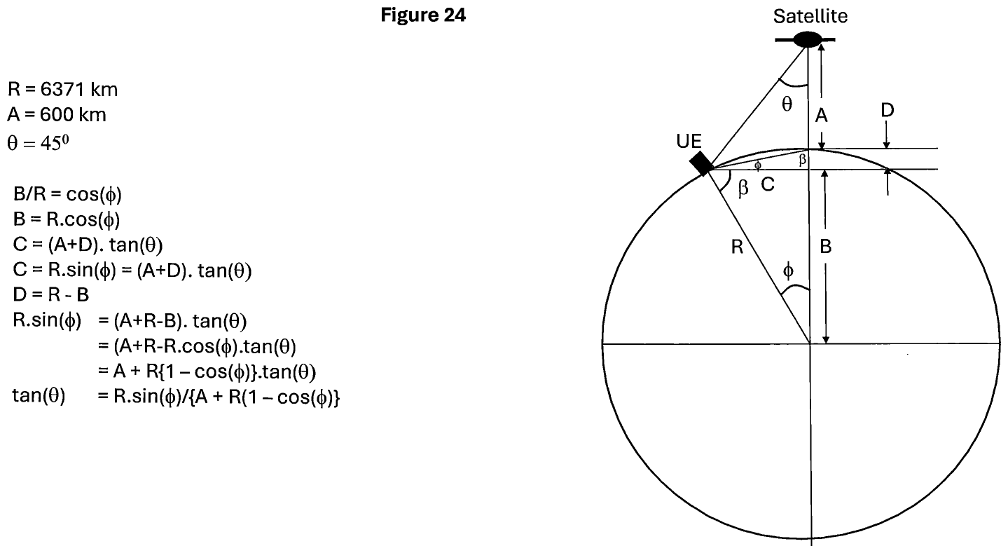

The basic Earth-satellite geometry for a single satellite is illustrated in FIG. 24. In the figure, q is the nadir angle and f is the central angle. The relationships between these angles are given below.

$$tan ( θ ) = R . sin ( ϕ ) / \{ A + R ( 1 - cos ( ϕ ) \} , \qquad ( 1 )$$

Using the above equation, we get the following example result.

Example at θ = 45 degrees

| R | 6371 | km |
|---|---|---|
| A | 600 | km |
| ϕ | 6.05 | degrees |
| | 0.1056 | radians |
| sin(ϕ) | 0.1054 | |
| tan(ϕ) | 0.106 | |
| tan(θ) | 1.0005 | |
| θ | 0.7856 | radians |
| | 45.013 | degrees |

It is clear from the above that, over the planned, +/−45° range of operation of the nadir angle, the central angle changes by a relatively small amount of +/−6°.

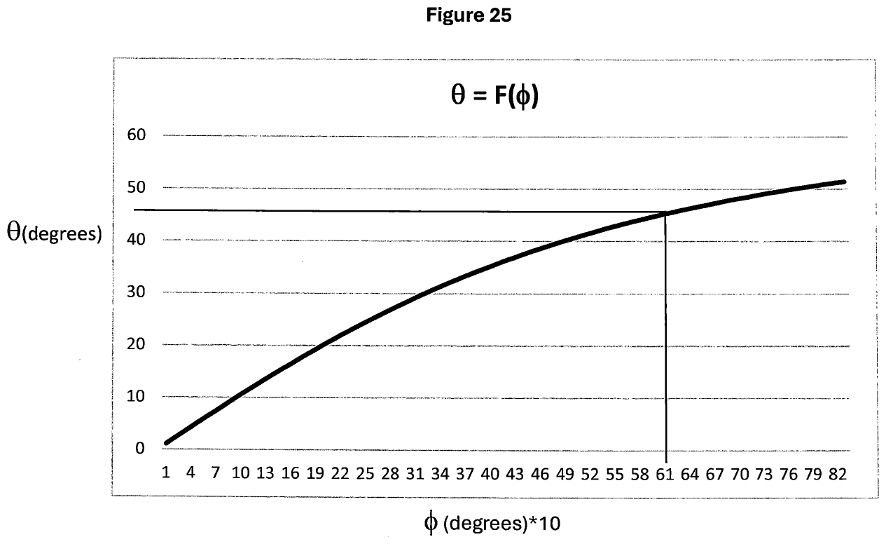

The relationship between the nadir and central angles is shown graphically in FIG. 25, and may be expressed by the functional relationship, θ=F(ϕ)

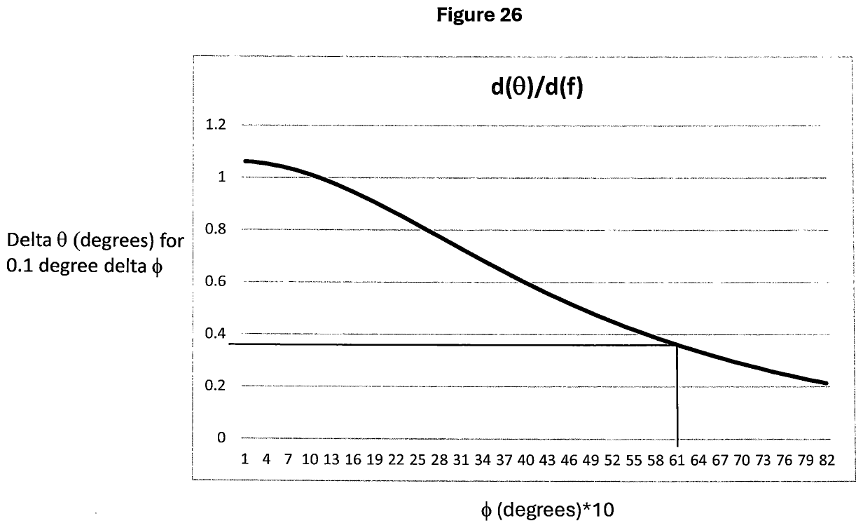

It is clear from the shape of F(ϕ) that the gradient, dθ/dϕ, is higher for lower values of nadir angles (ϕ). The gradient is plotted in FIG. 26.

Note that the gradient changes from 1.06/0.1=10.6 in the overhead case to 0.37/0.1=3.7 for a central angle (ϕ) of 61/10=6.1 degrees, which corresponds to a nadir angle of 45°. As the rate of change of the central angle, ϕ, is a constant for a LEO satellite in a circular orbit, a higher dθ/dϕ also means a higher dθ/dt. It will be shown below that a more rapid time-variation in θ results in a greater Doppler rate (time-rate of change in the Doppler frequency offset), and vice versa. In summary, Doppler rate will be maximum in the overhead case and less at greater nadir angles.

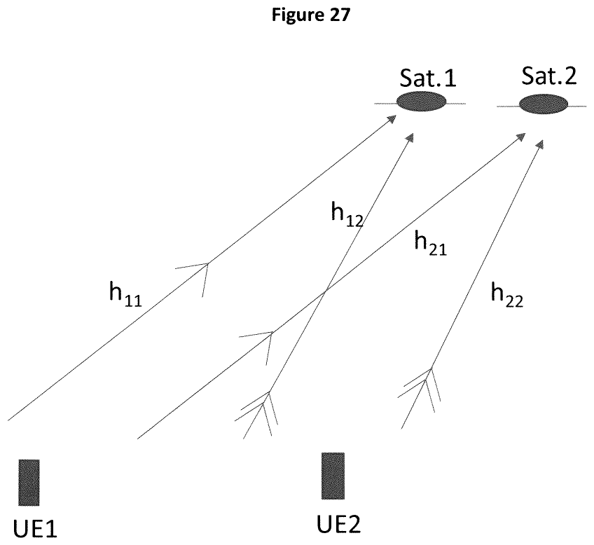

An analytical treatment of the Doppler shift characteristics, based on the propagation channel coefficients, is provided below. FIG. 27 illustrates a simple use case, comprising two satellites in the cluster and two UEs. The conclusions can be extended to arbitrary numbers of satellites and UEs.

### DEFINITION OF TERMS

[V1(t)]: Direction vector from UE1 to the satellite array center
[V2(t)]: Direction vector from UE2 to the satellite array center
hᵢⱼ: Complex channel-coefficient linking the transmit and receive signals of UE j and satellite i
xᵢⱼ: Complex signal received by satellite i from UE j
[X1(t)]: Signal vector received from UE1 by the satellite array, expressed as [x₁₁(t), x₂₁(t)]^{T}
[X2(t)]: Signal vector received from UE2 by the satellite array, expressed as [x₁₂(t), x₂₂(t)]^{T}
g₁(t): Complex modulation envelope of UE1 signal
g₂(t): Complex modulation envelope of UE2 signal
ω_{c}: Carrier frequency of transmitted signal
ω_{dij}: Doppler shift of carrier frequency received at satellite i on signal from UE j
Ψᵢⱼ: Phase of the signal received at satellite i from UE j, at a given time instant, relative to an arbitrary reference phase that is common for the entire satellite array.

For the simple, 2×2 system shown in FIG. 27, we have

$$\begin{matrix}{x}_{11} ( t ) = {g}_{1} ( t ) . {h}_{11} . exp j \{ ( {ω}_{c 11} ( t ) + {ψ}_{11} ( t ) \} \\ {x}_{21} ( t ) = {g}_{1} ( t ) . {h}_{21} . exp j \{ ( {ω}_{c 21} ( t ) + {ψ}_{21} ( t ) \} \\ {x}_{12} ( t ) = {g}_{2} ( t ) . {h}_{12} . exp j \{ ( {ω}_{c 12} ( t ) + {ψ}_{12} ( t ) \} \\ {x}_{22} ( t ) = {g}_{2} ( t ) . {h}_{22} . exp j \{ ( {ω}_{c 22} ( t ) + {ψ}_{22} ( t ) \}\end{matrix}$$

If the satellites were stationary, all ω_{cij} would be time invariant and identical. The relative phases, Ψᵢⱼ, would also be time invariant. The vector of phase shifts, [Ψᵢⱼ(t), Ψ₂ⱼ(t)]^{T}, indicates the direction vector, [Vⱼ(t)]⁴, i.e. ⁴ Note that amplitude plays no part in this vector as the transmit and receive antennas are assumed, for simplicity, to be omnidirectional.

[Vⱼ(t)]=[Ψ₁ⱼ(t),Ψ₂ⱼ(t)]^{T}

Clearly, [Vⱼ(t)] would be time-stationary if the satellites were stationary.

The satellite cluster moves in a circular orbit around the Earth. This causes [Vⱼ(t)] to be time variant. The equation of [Vⱼ(t)] is derived below as a function of the nadir angle, θ(t). From equation (3.1), we have

$$tan ( ⊖ ( t ) ) = R / \{ ( A / sin ( φ ( t ) ) + R \cdot tan ( φ ( t ) \} \qquad ( 2 )$$

$$\begin{matrix}Or ⊖ ( t ) = {tan}^{- 1} [ R / \{ A \cdot sec ( φ ( t ) ) + R \cdot tan ( ( φ ( t ) \} ] \\ = F \{ φ ( t ) \}\end{matrix}$$

The function, ι=F(φ), is illustrated in FIG. 25.

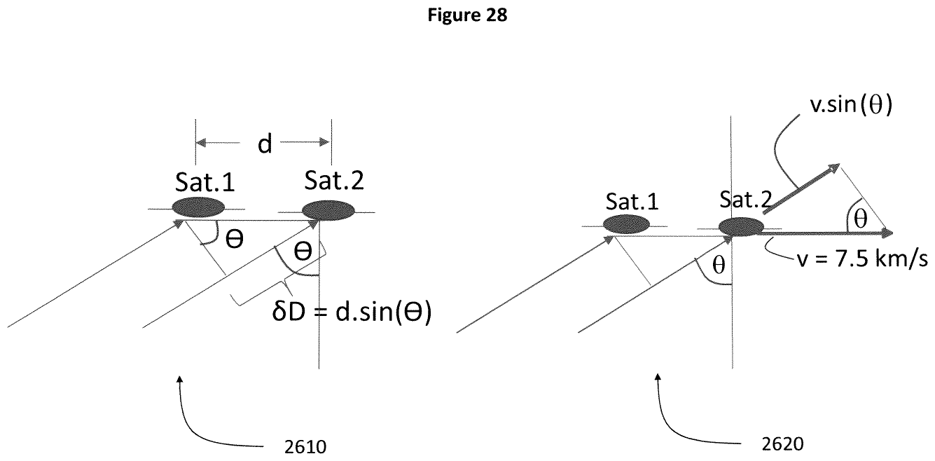

The relative phase between the signals received by Satellite 1 and Satellite 2 is derived below, as illustrated in FIG. 28 by the propagation geometry 2610.

$$\begin{matrix}δτ = d \cdot sin ( ⊖ ) / c \\ = d \cdot sin ( ⊖ ) / ( {f}_{c} ( t ) \cdot λ )\end{matrix}$$

Where δτ is the differential propagation delay.

Note that f_{c}, the received carrier frequency, includes Doppler shift caused by the motion of the satellites. f_{c} can be written as a fixed part, f_{c0}, which is the transmitted frequency (the frequency that would be received if the satellites were frozen in space), and a time varying part, f_{D}. Furthermore, due to the circular orbit, Doppler shift, f_{D}, is itself time variable, as discussed above. Thus, we have the following expression for the received frequency, f_{c}

$${f}_{c} ( t ) = {f}_{c 0} + {f}_{D} ( t )$$

The instantaneous phase shift between two array elements (satellites) is given by

$$δΨ ( t ) = {ω}_{c} ( t ) \cdot δτ , where {ω}_{c} ( t ) = 2 p \cdot {f}_{c} ( t )$$

Where δτ is the differential propagation delay between the wavefronts reaching Satellite 1 and Satellite 2 from UE1, or the corresponding differential pathlength, δD, divided by the velocity of light, c. Thus, we have

δτ=8D/c

where δD is given by the projection of the direction vector to UE1, i.e. [V1(t)], on the direction vector from Satellite 1 to Satellite 2 as shown in FIG. 28 by the propagation geometry 2610.

The relative phase shift, Ψ(t), resulting from the propagation path difference will be given by

$$\begin{matrix}Ψ ( t ) = β \cdot d \cdot sin ( ⊖ ( t ) ) \\ = ( 2 π / c ) \cdot {f}_{c} \cdot d \cdot sin ( ⊖ ( t ) )\end{matrix} \qquad ( 3 )$$

where,
β is the spatial rate of change of phase in radians/m
θ is the nadir angle.

Assume that θ(t) varies relatively slowly with time, as is true in our case. For nadir angles other than approximately overhead, there will be a substantial component of the instantaneous (i.e. tangential) velocity of the satellites in the direction projected towards the UE, given by v.sin (θ), as shown in FIG. 28, propagation geometry 2620. As a UE projects a relatively small solid angle to the satellite cluster, the Doppler shift variation over satellites is also relatively small. The mean Doppler shift over all satellites may be referred to as the Common Doppler shift. As the nadir angle changes relatively slowly with time, this Common Doppler shift is quasi-stationary over T_{block}, which is 10 ms in the present system. This is the: time period of significance for the MIMO algorithms.

The Common Doppler shift, caused by v.sin (θ), will be substantially the same for all satellites as θ is substantially similar for all satellites, as mentioned above. It is given by

$$Common Doppler shift = \{ ( v \cdot sin ( ⊖ ) / c \} \cdot {f}_{c} Hz$$

The Doppler rate may be found by taking the time derivative of the Common Doppler shift

$$\begin{matrix}Doppler rate & = & d / dt [ \{ ( v \cdot sin ( ⊖ ) / c \} \cdot {f}_{c} ] Hz / s & ( 4 ) \\ & = & \{ v \cdot cos ( θ ) / c \} \cdot {f}_{c} \} \cdot d ( θ ) / dt Hz / s & ( 5 ) \\ & & & \end{matrix}$$

In this scenario, the Common Doppler shift goes from approximately 14 kHz at θ=45° to 0 Hz at θ=0°. The corresponding values of Doppler rates are 52 Hz and 199 Hz, approximately. See calculations in Table AI.1 below.

TABLE AI.1
Common Doppler shift and Doppler rate at nadir angles of 45° and 0°

| pi | 3.1416 | | 3.1416 | |
|---|---|---|---|---|
| C | 3.00E+08 | m/s | 3E+08 | |
| freq. | 8.00E+08 | Hz | 8E+08 | Hz |
| v | 7.50E+03 | m/s | 7500 | m/s |
| θ | 45 | degrees | 0 | degrees |
| | 0.7854 | radians | 0 | radians |
| sin(θ) | 0.707108 | | 0 | |
| v · sin(θ) | 5.30E+03 | m/s | 0.00E+00 | m/s |
| Instantaneous | ={v · sin(θ)/c} · freq. | | ={v · sin(θ)/c} · freq. | |
| Doppler | 1.41E+04 | Hz | 0.00E+00 | Hz |
| | 14.14216 | kHz | 0 | kHz |
| d(θ)/dt | 0.21 | degrees/s | 0.57 | degrees/s |
| | 0.003665 | radians/s | 0.009948 | radians/s |
| Doppler rate | =[{v · cos(θ) · d(θ)/dt}/c] · freq. | | =[{v · cos(θ) · d(θ)/dt}/c] · freq. | |
| | 51.83366 | Hz/s | 198.968 | Hz/s |

As mentioned above, strictly speaking, Θ(t) is non-stationary; however, it changes relatively slowly at the rate of 0.21 degrees/s when the nadir angle is 45° and 0.57 degrees/s when the satellites are overhead. This means that the relative phase shift between the elements will change at the rate of

$$\begin{matrix}d Ψ ( t ) / dt = β \cdot d \cdot \{ sin ( ⊖ ( t ) \} / dt \\ = β \cdot d \cdot cos ( ⊖ ( t ) ) \cdot d ⊖ ( t ) / dt \\ = ( 2 π / l ) \cdot d \cdot cos ( ⊖ ( t ) ) \cdot d ⊖ ( t ) / dt \\ = ( 2 π / c ) \cdot {f}_{c} \cdot d \cdot cos ( ⊖ ( t ) ) \cdot d ⊖ ( t ) / dt \\ = K \cdot cos ( ⊖ ( t ) ) \cdot d ⊖ ( t ) / dt\end{matrix} \qquad ( 6 )$$

### Where

$$K = ( 2 π / c ) \cdot {f}_{c} \cdot d$$

Note also that the central angle, ϕ, changes linearly with time at the rate of 12.6 milliradians/s or 0.7221 degrees/s.

### Observations:

1. From equation 3, Ψ varies linearly with the frequency, f_{c}. This explains why every element of the direction vector, [Vⱼ], is linearly frequency dependent.
2. Over short time periods, e.g. less than T_{block}=10 ms, Ψ(t) is essentially constant, i.e. the direction vector, [Vⱼ], is essentially stationary. This is because q(t) changes very little over T_{block}.
3. Over medium time periods, e.g. 10-100 ms, y is a linear function of time. This is evident from equation (4), where dΨ/dt is proportional to dθ/dt, which is essentially constant over 100 ms for the following reasons: θ is a linear function ϕ over small ranges of ϕ, as shown in FIG. 25; ϕ is a linear function of time as the angular velocity of the satellite cluster is constant; therefore, θ is also a linear function of time. This leads to the important conclusion: The direction vector, [Vⱼ], is a linear function of time over periods under 100 ms in the present system.⁵ ⁵ In the present context, a “vector being a linear function of time” means that every element of the vector is a linear function of time.
4. Over still longer periods, Ψ changes non-linearly with time, i.e. dΨ/dt varies with time over the period.

The above analysis shows why Ψ(t) is linearly extrapolatable over both time and frequency—these attributes are foundational to the present system architecture. Appendix II shows the simulations results verifying that Ψ(t) varies linearly with time and frequency.

### Appendix II: Simulation Results of Time- and Frequency-Extrapolation of Uplink, Channel Coefficient (or Direction) Vectors

### Simulation Experimental Procedure

UL simulations of were performed with the Close UE Separation scenario shown in FIG. 3. The normalized direction vector, [X]′, was collected from the simulation results and analyzed. To examine the time variation of [X]′, the time evolution of [X]′ was observed as the satellite cluster moved in its orbit. Runs of various time duration were studied, using two starting positions-nadir angle of 45° and 0° (overhead case).

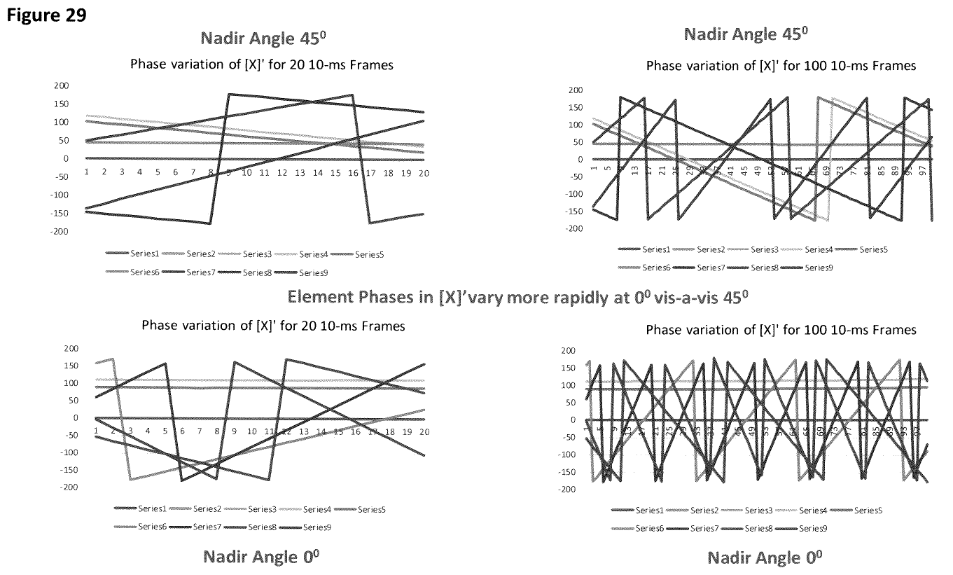

FIG. 29 shows simulation results from example, short and long time-evolution runs of 200 ms and 1 s respectively, for both 45° and 0° nadir angles. For each time sample (one sample per 10-ms Frame) the phase of [X]′ in degrees is shown, noting that for antenna #1, the phase is always 0° owing to normalization of the vector. The amplitudes of the channel coefficients are not shown as the are close to 1 due to the assumption of isotropic antennas, discussed above. Thus [X]′ is represented by the set of phase values for each x-axis sample, which is the Frame #.

### Observations Re: Time Variation of [X]′

There is little variation in [X]′ within a Frame, i.e. T_{block} period of 10 ms.
For periods greater than 10 ms—including up to periods of 1 s—the variation of [X]′ with time is substantially linear. Note that, because the SuperFrame duration is 100 ms, it suffices that the variation of [X]′ with time be linear up to 100 ms. A new set of pilot signals are sent at the start of each Frame, so even if the gradient of [X]′ changes materially between Frames, it will be tracked by the channel coefficient vector re-estimation in each Frame #0.
The variation of [X]′ with time is more rapid for the overhead case (nadir angle of 0°), than when the nadir angle is 45°. This is consistent with the observation that the Doppler rate is highest in the overhead case.

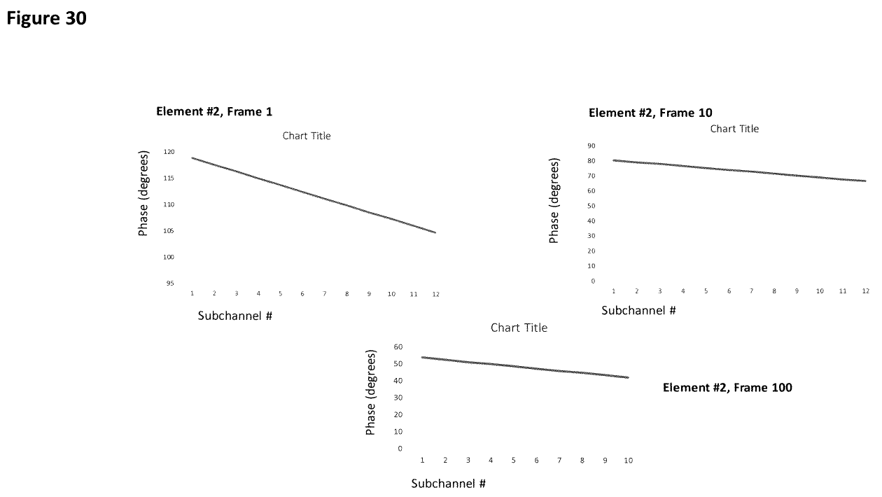

To examine the frequency variation, time evolution runs of [X]′ were recorded for different 15 kHz subchannels (i.e. pilot channels). Then, the phase data for specific satellite element (#2) was compared for different subchannels. The variation of [X]′ with frequency (Subchannel #) is visualized in FIG. 30 for Frames 1, 10 and 100.

### Observations Re: Frequency Variation of [X]′

For a given Frame, the phases of the elements of [X]′ vary linearly with frequency (i.e. over the domain of subchannels). This means that [W]ₒₚₜ can be determined for any subchannel by linear extrapolation from a pilot subchannel, if the frequency gradient of [X]′ between the pilot subchannel pair is known. Like time extrapolation, frequency extrapolation of [X]′ (and thereby [Wₒₚₜ]), is a foundational aspect of the present system's CONOPS, as it allows the pilot signal overhead to be greatly minimized.
   Investigations were performed on the extrapolation of [X]′ over frequency offsets up to 1080 MHz—linearity was observed at all offsets.

### Appendix III: Analytical Bases of Channel Coefficient Vector Estimation Method-B

FIG. 31 shows a MIMO propagation scenario 3100 involving M UEs 3120 and N satellites 3110, the latter forming a phased array antenna in accordance to the teachings of the present disclosure. The following are noteworthy.

The received, N-dimensional vector of signals from M UEs is given by

$$[ X ( t ) ] = {[ {x}_{j} ( t ]}^{T} , j = 1 to N$$

$${x}_{j ( t )} = {x}_{Ij} ( t ) + {x}_{2 j} ( t ) + … + {x}_{Mj} ( t )$$

Note that x_{Rij}=x_{Tij}.hᵢⱼ
where hᵢⱼ is the complex channel coefficient. In an LOS channel without multipath

$${h}_{ij} = L \cdot exp j ( {ω}_{di} t + f ) \qquad ( 1 )$$

where
L: Path loss in linear units
ω_{di}: 2π. (Doppler frequency shift in Hz of the signal from the ith UE)
f: Arbitrary phase reference at the receiver, which is common for all satellites through mutual time synchronization. Therefore, this term can be ignored, so that we have

hᵢⱼ=L·expj(ω_{d}t)

Note that here the channel coefficient varies rapidly with time (at the Doppler frequency). In terrestrial cellular channels, the channel coefficients are assumed to be time invariant over the coherence time (as per the definition of coherence time), on the assumption that the Doppler has been removed. We have incorporated removing most of the Doppler frequency shift into the [R_{xd}] correlation process, as shown below. After the above Doppler removal, we are left with a satellite channel where the coherence time is relatively long (10 ms), during which hᵢⱼ is materially time invariant.

The L term in equation (1) can also be dropped as, based on geometry, it will be very similar for all satellites 3010. In other words, the received x_{Rij} are referenced to a point in space that is approximately the center of the satellite cluster. This yields

$${h}_{ij} = exp j ( {ω}_{d} t ) \qquad ( 2 )$$

Therefore, [R_{xd}] is given by

$$[ {R}_{xd} ( i , j ) ] = [ < ( {h}_{ij} {s}_{i} ( t ) ) * \cdot {x}_{j} ( t ) > ] for j = 1 to N , \\ assuming {h}_{ij} has been estimated \qquad ( 3 )$$

$$\begin{matrix}< ( {h}_{ij} {s}_{i} ( t ) ) * \cdot {x}_{j} ( t ) > = < ( {h}_{ij} {s}_{i} ( t ) ) * \cdot \{ {x}_{1 j} ( t ) + {x}_{2 j} ( t ) + … + \\ {x}_{ij} ( t ) … + {x}_{Mj} ( t ) \} > \\ = < ( exp j ( {ω}_{di} t ) \cdot ( {s}_{i} ( t ) ) * \cdot \{ {x}_{1 j} ( t ) + \\ {x}_{2 j} ( t ) + … + {x}_{ij} ( t ) … + {x}_{Mj} ( t ) \} >\end{matrix}$$

If ωdI were known, we could implement equation (3) to find [R_{xd}]. All terms, except expj(ω_{dI}t). (s_{I}(t))*. {x_{iI}(t)}, where I represented the desired UE, would tend to zero upon the time averaging indicated by <⋅>. Note that, unlike in traditional systems lacking Doppler compensation, the Doppler shift present in x_{Ij}(t) would be canceled by expj(ω_{dI}t)*; consequently, the modulation terms would integrate coherently and, therefore, the magnitude of [R_{xd}] would not tend to zero (as in traditional systems lacking Doppler compensation). In summary, we could use equation (3) to calculate [R_{xd}] if we knew ω_{dI}. The question now faced is the determination of ω_{dI}?

One approach for finding the Doppler shift, ω_{dI}, is to implement equation (3) without the Doppler compensation indicated by expj(ω_{dI}(t)*, and without the time averaging indicated by <⋅>. In other words, implement f (t) for each time sample, as shown below in equation (4) below.

$$f ( t ) = ( {s}_{i} ( t ) ) * \cdot \{ {x}_{1 j} ( t ) + {x}_{2 j} ( t ) + … + {x}_{ij} ( t ) … + {x}_{Mj} ( t ) \} \qquad ( 4 )$$

We now take the Fourier Transform (FT) of f (t) as shown in (5) below, with a frequency resolution substantial smaller than the OFDM channelization of 15 kHz. This requires the time window of the FT to be much greater than the subframe duration of 1 ms.

$$F \{ f ( t ) \} = F \{ {s}_{i} ( t ) * \cdot {x}_{ij} ( t ) \} , i = 1 , to M , j = 1 to N \qquad ( 5 )$$

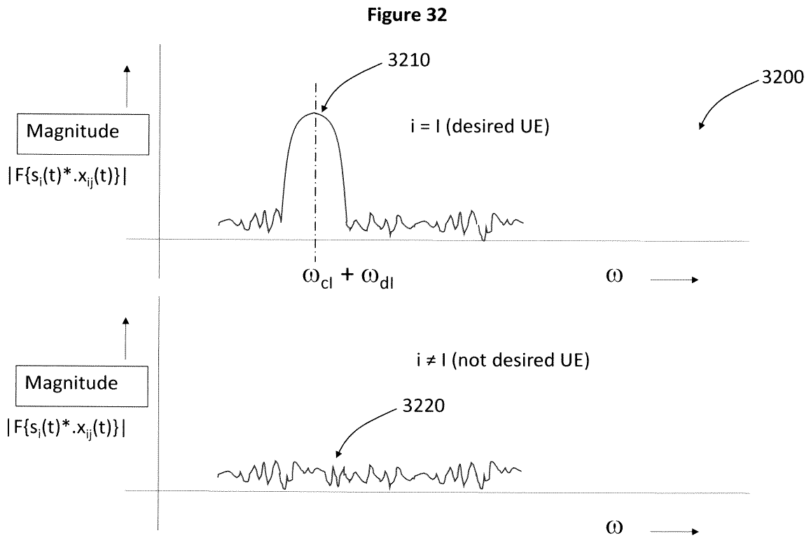

From basic signal processing theory it is known that, for i=I, and for each j (satellite index), the term inside {⋅} will be constant over time, t (as multiplying the received pilot signal by a local, synchronized, and complex-conjugated, copy of the same signal will reverse its modulation). Therefore, the FT will be a delta function at the frequency of the subcarrier, i.e. ω_{cI}+ω_{dI}, where ω_{cI} is the transmit frequency (radians/s) of the Ith UE. The delta function in the frequency domain will manifest itself as a spectrum peak, such as 3210 in an example spectrum 3200 illustrated in FIG. 32, resulting from plotting equation 5. For all other components of sᵢ(t)*.xᵢⱼ(t)}, where i≠I (the index of the desired UE), the above-mentioned modulation reversal will not occur, and F{sᵢ(t)*·xᵢⱼ(t)} will be a noise-like function of frequency, as illustrated by 3220 in FIG. 32.

It should also be clear that a spectrum peak such as illustrated in FIG. 32 will be obtained for each j (satellite index). Moreover, for each UE, two different spectra, separated by 90 kHz, will be obtained as each UE is assigned two pilot signals (see FIG. 14). It is noteworthy that the spectrum is complex-valued (Figure AII.2 shows the magnitude of the complex spectrum) as all signal processing is performed at complex baseband. The spectra of the signals received via N satellites will form an N-dimensional vector. By searching for the magnitude-peaks of each spectrum, using peak search methods well known in the prior art, it is possible to identify the peak (complex) values of the N spectra. This will correspond to the direction vector of the signal arriving as the satellite cluster from the Ith UE. The direction vectors to other UEs can be found similarly by using the appropriate value of sᵢ(t) in equation (3).

It is noteworthy that computing the FT over 5 ms, rather than the 1 ms that would be required for Subcarrier channelization corresponding to OFDM demodulation (as performed in Method-A described above) has the benefit that, it implicitly performs the averaging over 5 frames required for estimating [X(i, hp1, hp2)] in both Method-A and Method-B for channel coefficient vector estimation.

1. A wireless communication system comprising:
terrestrial user equipment transmitters; and
satellite receivers using a phased array antenna, the phased array antenna comprising a plurality of antenna elements,
wherein the communication system uses an air interface operating over a wireless channel that is characterized by a channel coefficient between each pair of transmitter and receiver,
wherein the plurality of channel coefficients between a user equipment and a plurality of satellite antennas forms a channel coefficient vector,
wherein the transmitters and receivers exchange unknown user signals and known pilot signals,
wherein receiving a user signal by a plurality of satellite receivers requires the receivers to estimate a channel coefficient vector, and
wherein the channel coefficient vectors are determined by receiving pilot signals during first epochs when pilot signals are transmitted, and estimated using time-extrapolation from corresponding channel vectors during second epochs when pilot signals are not transmitted.

2. The system of claim 1 wherein the satellites comprise a fractionated satellite, and wherein antennas on individual satellites comprise the elements of the phased array antenna.

3. A wireless communication system comprising:
terrestrial user equipment transmitters; and
satellite receivers using a phased array antenna,
wherein the phased array antenna comprises a plurality of antenna elements,
wherein the communication system uses an air interface operating over a wireless channel that is characterized by a channel coefficient between each pair of transmitter and receiver,
wherein the plurality of channel coefficients between a user equipment and a plurality of satellite antennas forms a channel coefficient vector,
wherein the transmitters and receivers exchange unknown user signals and known pilot signals,
wherein receiving a user signal transmitted over the wireless link which requires the receiver to estimate a channel coefficient vector, and
wherein the channel coefficient vectors can be determined by receiving a set of pilot signals in first frequency-subbands in which the pilot signals are transmitted, and using frequency-extrapolation to estimate corresponding channel coefficients in second frequency-subbands in which no pilot signals are transmitted.

4. The system of claim 3 wherein the satellites are components of a fractionated satellite, wherein antennas on individual satellites comprise the elements of the phased array antenna.

5. A wireless communication system comprising a fractionated satellite,
wherein the fractionated satellite consists of a plurality of satellites forming a phased-array antenna, and
wherein the phased array antenna is used for uplink and downlink wireless communication with user equipment on the ground,
wherein the wireless communication system uses both beamforming and MIMO technologies to spatially isolate the radio link between a given transmitter and receiver pair from co-frequency radio links between other transmitter and receiver pairs of the same network,
wherein beamforming technology is used for user equipment that are spaced apart by more than a threshold distance and MIMO technology is used for user equipment spaced less than the threshold distance.

6. The system of claim 5, wherein the minimum distance to achieve isolation between a transmitter and receiver pair using beamforming technology is between one and three beamwidths.

7. The system of claim 5, wherein the uplink and downlink processing in a satellite transceiver is partitioned between a beamforming processor and a MIMO processor, wherein the two processors can be operated independently.

8. A method of wireless communications between a terrestrial transmitter and a satellite receiver wherein the signal is received with a Doppler frequency shift, and wherein the transmitted signal contains a plurality of frequency multiplexed pilot signals occupying a net channel bandwidth,
wherein the pilot signal for each transmitter is created by modulating a carrier signal by a unique baseband sequence identifying the transmitter, and
wherein the Doppler-free modulation envelope of each pilot signal is determined by the steps of
receiving a full-bandwidth signal occupying the net channel bandwidth,
multiplying the full-bandwidth signal by a local, complex-conjugated, copy of the pilot signal sequence corresponding to a desired transmitter to create an objective time-domain signal,
transforming the objective time-domain signal to an objective, frequency-domain signal by Fourier transformation,
identifying the frequency of the peak of the magnitude of the objective, frequency-domain signal,
identifying the complex value of the objective, frequency-domain signal at the frequency of the peak magnitude as the objective, Doppler-free modulation envelope.
